(19) United States
(12) Patent Application Publication
(10) Pub. No.: US 2019/0158544 A1
(43) Pub. Date: May 23, 2019

(54) APPARATUS AND METHOD FOR EFFICIENTLY REALIZING ONLINE AND OFFLINE TELEPHONY IN CONNECTION WITH THE TRANSFER AND EVALUATION OF USER-SPECIFIC DATA

(71) Applicant: telequest & Internet Solutions GmbH, Graz (AT)

(72) Inventor: Stephan OHNECK, Calvia/Bendinat (ES)

(21) Appl. No.: 16/252,390

(22) Filed: Jan. 18, 2019

Related U.S. Application Data
(63) Continuation of application No. PCT/EP2017/068558, filed on Jul. 21, 2017.

(30) Foreign Application Priority Data
Jul. 21, 2016 (DE) 102016213389.6

(51) Int. Cl. H04L 29/06; G06F 16/955; G06F 16/9538; H04L 29/08; G06Q 30/02

(52) U.S. Cl. CPC H04L 65/1069; G06F 16/9558; H04M 11/06; H04L 67/02; G06Q 30/0273; G06F 16/9538

(57) ABSTRACT

An apparatus for retrieving a website from a web server and for establishing a communication connection includes a send/receive interface configured to request and to receive from the web server a transmission of the website; an output module configured to output the website to a user and to further indicate to the user that there is the possibility of establishing the communication connection, the communication connection being an audio and/or video connection; an input interface by means of which the user indicates that the communication connection is to be established; a processor module configured to generate a connection-establishment message that requests the establishment of the communication connection with a communication unit. The send/receive interface is configured to send the connection-establishment message to a switching center and, after sending the connection-establishment message, to send and receive audio and/or video data to/from the communication unit.

### CROSS-REFERENCES TO RELATED APPLICATION

This application is a continuation of copending International Application No. PCT/EP2017/068558, filed Jul. 21, 2017, which is incorporated herein by reference in its entirety, and additionally claims priority from German Applications No. DE 10 2016 213 389.6, filed Jul. 21, 2016, which is incorporated herein by reference in its entirety.

### BACKGROUND OF THE INVENTION

The application refers to IP telephony (IP=Internet Protocol) and in particular to an apparatus and a method for efficiently realizing anonymous IP telephony, in particular by means of a 1-Click-Call on a website.

Today, many users use search engines, not only to search for companies, shops or providers of goods and services, but also to find a telephone contact (telephone number). The telephone contact still plays an important role.

With regard to telephony, different approaches exist in the conventional technology, which may be assigned to different groups of technologies.

The traditional approach with respect to telephony is the classic telephony via a PSTN (Public Switched Telephone Network), a telephone network being a communication system that is designed for handling telephone conversations, i.e. for telephony.

Mobile telephony is a further telephony approach, which has been widely used since the 1990s.

Today, classic telephony is still a widely accepted means of communication. In Germany, a conversion of the entire telephone network is currently on the way. All network operators are discontinuing the operation of the previously used PSTN (Public Switched Telephone Network). All connections will gradually be converted to the NGN (Next Generation Network), which is IP-based (keyword: VOIP/SIP) (see:

[1a]: https://de.wikipedia.org/wiki/Telefonnetz or:

[1b]: https://en.wikipedia.org/wiki/Public_switched_telephone_network)

The landline network and the mobile telephone network have important structural elements in common. Both, a landline network and also a mobile telephone network comprise an access network, a connection network, and a signaling network (cf.: [1a]: https://de.wikipedia.org/wiki/Telefonnetz or: [1b]: https://en.wikipedia.org/wiki/Public_switched_telephone_network).

A common feature of landline and mobile telephone networks is the mandatory registration of terminal devices in this network. Only a registered participant may make calls within this network (cf. landline connection or SIM card in mobile telephone connections). Anonymous telephony without prior registration is therefore not possible when using a landline network or a mobile telephone network.

A further modern telephone approach is IP telephony, in particular VoIP (Voice over IP) and especially SIP telephony (SIP=Session Initiation Protocol).

IP telephony (Internet Protocol telephony), which is also generally referred to as internet telephony, is telephony via computer networks that are set up according to internet standards. For example, voice and control information, e.g. control information for establishing a connection, are transferred via a network that is usable for data. At the call participants, e.g., computers, or telephone terminal devices that are specialized for IP telephony, or classic telephones that are connected via special adapters may establish the connection or be used for calling.

With IP telephony according to the conventional technology, a mandatory prerequisite for establishing a call to any participant within this network is a central instance at which a terminal device, e.g. which may be partially realized by means of software, has to log in.

A further approach are so-called “telephone systems in the cloud” (in the sense of “computer cloud”). A telephone system in the cloud is designed as an alternative to traditional telephony. It is mainly companies that use this option to realize cost advantages over traditional telephony, e.g. see:

[2a]: https://de.wikipedia.org/wiki/IP-Telefonie or:

[2b]: https://en.wikipedia.org/wiki/Telephony.

Further telephony concepts may be seen in the transition and in the convergence of the networks as they are developed under the buzzword Next Generation Network (NGN network). Classic telephony (or the underlying networks) is currently being “raised” to the next generation. Particularly for end customers, the old technologies will be mapped to IP, or the internet. From the end customers' point of view, nothing changes in the nature of communication. Essentially, on the part of companies, cost reasons are decisive for this approach. Even in such Next Generation Networks, a central instance at which the participants are registered is still involved (for NGN, see in particular:

[3a]: https://de.wikipedia.org/wiki/Next_Generation_Network or

[3b]: https://en.wikipedia.org/wiki/Next-generation_network).

All conventional telephone networks use the signaling system #7, which is also generally referred to as SS7. SS7 is a collection of protocols and methods for signaling in telecommunication networks, see for example:

[4a]: https://de.wikipedia.org/wiki/Signalling_System_7 or

[4b]: https://en.wikipedia.org/wiki/Signalling_System_No._7.

For storing telephone numbers, e.g., classic telephones comprise a number storage. EP 398 711 B1 (cf. [5]) shows such a telephone with a number storage, enabling a simple connection establishment. From websites, a simple connection establishment is also desirable.

On websites, telephone numbers are often not displayed as links, but as classic continuous text. Often, telephone numbers are also displayed as classic continuous text on a website that is a search result provided by a search engine. A click on this text (telephone number) does not in itself trigger an action—at least not one that the designer of the website would have intended. Rather, it is up to the web browser to interpret the click on a telephone number and to link it to an action. Depending on the browser (and the operating system), a different action is performed.

Alternatively, a telephone number on a website may be packed into a Tel link which could have the form: <a href=“tel:+4912345679000”>+49 12345679000</a>, cf.:

[6]: http://blog.linkwerk.com/2011/04/telefon-links-fur-smartphones-desktopfreundlich/).

Depending on the web browser and the programs and apps installed on the computer or smartphone, when clicking on the link, either nothing happens or a media discontinuity occurs; another program outside of the browser is started. For example, with an Android smartphone, a pop-up window with the dial app of the smartphone (dial program/dial application) is opened, e.g., the dial app completely covering the website.

FIG. 2 shows an example of such a dial app.

When the dial app is opened, there is a change of app, and the focus (browser) disappears. There is a media discontinuity, and at this point the customer journey comes to an end. Basically, the problem of the media discontinuity exists with current telephony solutions in PSTN and also with SIP connections. To establish a connection, the screen (on the smartphone) is overlapped, representing a media discontinuity.

The interruption of the customer journeys means that the focus of the customer is now no longer on the (hidden) website, but that his/her journey has ended, or has at least been interrupted, by the fade-in of the dial app. For example, this is undesirable because it is no longer possible to provide the customer with further information via other websites, or to receive feedback from the customer by interaction via entries on the website.

At the very least, the customer journey may only be incompletely tracked. When clicking on a telephone number and changing the “medium”, important data of the customer journey is missing. Services for data traffic analysis, such as Google® Analytics or comparable systems, do not receive any information of the actual call or the result of dialing. For example, the result of a telephone call may not be used for the further dialogue with the user on further websites.

FIG. 3 shows a corresponding example of a website that is provided in response to a search request of an internet search engine.

A further telephony concept of the conventional technology is realized by “Google Hangouts” ®. In a web browser, e.g. Firefox®, a telephone number may be displayed as a link. For example, clicking this link takes the user to “Google Hangouts” ®. For example, such a telephone number may be displayed in a so-called “Google Business” ® banner (regarding “Google Business” ®, see:

[7a]: http://www.google.com/intl/de_de/business/ or

[7b]: http://www.google.com/intl/en_en/business/).

“Google Hangouts” ® is a video conference and instant messaging service of the US company Google® (for more information, see for example:

[8]: https://hangouts.google.com/?hl=en).

A further telephony concept is WebRTC® as a peer-2-peer connection.

WebRTC® (Web Real-Time Communication) is a collection of communication protocols and programming interfaces (API) for implementation in web browsers, allowing them real-time communication via computer-computer connections. For example, the browsers Firefox®, Chrome®, and Opera® support the WebRTC® technology.

As a result, browsers are not only able to retrieve data resources from backend servers, but may also retrieve (real-time) information from browsers of other users (about WebRTC®, see:

[9a]: https://de.wikipedia.org/wiki/WebRTC or

[9b]: https://en.wikipedia.org/wiki/WebRTC).

Computers in this sense are IP-supported end points. A additional software is not required, as modern browsers already have WebRTC® capabilities. Browser plugins or addons are not required to use the technology. With this, the application is not bound to an operating system, i.e. it is platform-independent.

WebRTC® was developed for peer-2-peer communication. Users may exchange data (audio and/or video and/or other data) between browsers.

WebRTC® is completely integrated into certain browsers and does not require any plugins, etc. An implementation of WebRTC® is integrated into the web browser Firefox®, cf.:

[10a]: http://www.pro-linux.de/artikel/2/1791/firefox-hello-der-videochat-im-test.html or

[10b]:https://support.mozilla.org/en-US/products/firefox/chat-and-share/firefox-hello-webrtc

under the feature name “Hello”. In order to use “Hello”, a special user account is not required. However, an invitation has to be sent. This invitation, which comes in the form of a URL (URL=Uniform Resource Locator) and which, e.g., may be sent in an e-mail, is the prerequisite for establishing the communication of the participants.

In principle, the following applies for each solution that is based on WebRTC®: The present terminal device/end point/software (device) has to comprise the following features: The terminal device has to be WebRTC®-enabled (if applicable, the use of a browser that is WebRTC®-enabled), it has to comprise a microphone and a loudspeaker, and an internet connection of the device in question (e.g. a smartphone or laptop) or an intranet connection has to be available. Optionally, a video camera may be used if video transfer is to be used.

WebRTC® with the extension of a SIP stack or other libraries is a special telephony concept. Some producers offer JavaScript libraries that run with a browser and provide extended functions or interfaces. Based on WebRTC®, the JavaScript library SIP.js may be used. This library uses the basic functionality of WebRTC® and, based thereon, adds a so-called SIP stack (signaling/example: DTMF and data transfer). Thus, SIP connections (VoIP connections) to a SIP server may be established within the browser. This corresponds to a software device for SIP telephony (see:

[11]: http://sipjs.com/)

Subsequently, reference is made to the following document:

[12]: Aameek Singh, Arup Acharya, “Using session initiation protocol to build context-aware VoIP support for multiplayer networked games”, published in: Proceeding NetGames '04, Proceedings of 3rd ACM SIGCOMM workshop on Network and system support for games, pages 98-105, ACM New York, N.Y., USA, 2004.

The above document of Singh and Acharya introduces SIP techniques that exchange via the SIP protocol further data for the management of an online game (so-called browser games).

Furthermore, in the conventional technology, there is the FreeSwitch® project with the module “mod_verto” (see:

[13]: https://freeswitch.org/confluence/display/FREESWITCH/mod_verto),

which enables the browser (with the help of the corresponding JavaScript Library) to function as a software device for VoIP telephony.

A further important concept that is of particular significance in the field of the telephony is value-added services, which may also be referred to as value-added telephony. As far as value-added telephony is concerned, there is already the possibility, as a generally used concept, of charging for added values within the framework of telephone calls. In Germany, e.g., the 0900 numbers are known, also referred to as 0900 lane, via which it is possible to bill added values via the call that is subject to particular costs. A brief overview of the current conventional technology with regard to 0900 numbers in Germany may be found, e.g., on the following website:

[14] http://www.elektronik-kompendium.de/sites/kom/0312241.htm.

Abroad, there are concepts that correspond to the 0900 numbers in Germany. The current fee system in this model is relatively limited and the fees differ significantly depending on the origin of a caller, wherein a call from the German mobile telephone network is much more expensive than a call from the German landline network. The end customer fee in the mobile telephone network also differs between different network operators. However, an excessive increase in the price of the added value offered is also undesirable for some value-added providers, as the added values may then partially not be sold. It would be desirable to technically realize value-added telephony with a greater flexibility in the pricing as is currently possible with 0900 numbers.

“Android Pay” @ is a payment system of the US company Google® for Android devices. The service officially started on Sep. 10, 2015. Currently, the service may only be used in the US (see:

[15]: https://www.android.com/pay/ and:

[16a]: https://de.wikipedia.org/wiki/Android_Pay or

[16b]: https://en.wikipedia.org/wiki/Android_Pay).

To sum up the conventional technology, all public communication networks need every user (or terminal device) to be authorized and log in to a central instance so that both outgoing and incoming connections may be established. Authorization takes place in advance. Furthermore, every communication network is based on the idea that the B-participant (the participant that is called) may be freely called or selected. There are no differences between the different networks (e.g. PSTN, VoIP) with regard to these points.

The goal of newer technologies such as WebRTC® is a peer-2-peer connection. In other words, a connection is established without a central instance. For this, an invitation (in the broadest sense) is mandatory. Even if central switching instances are used in techniques such as WebRTC®, these scenarios have the goal of freely calling a B-participant.

### SUMMARY

According to an embodiment, an apparatus for retrieving a website from a web server and for establishing a communication connection may include: a send/receive interface configured to request a transmission of the website from the web server, and configured to receive the website from the web server, an output module configured to output the website to a user, wherein the output module further indicates to the user that there is the possibility to establish the communication connection, wherein the communication connection is an audio connection or an audio/video connection or a video connection, and an input interface configured to receive an input of the user, by which the user indicates that the communication connection is to be established, a processor module configured to generate a connection-establishment message that requests the establishment of the communication connection with a communication unit, wherein the send/receive interface is configured to send the connection-establishment message to a switching center, wherein the send/receive interface is configured to, after sending the connection-establishment message, send audio data or audio/video data or video data to the communication unit and to receive the same from the communication unit.

According to another embodiment, a system for retrieving a website, for providing the website and for establishing a communication connection may include: an inventive apparatus, and a web server, wherein a send/receive interface of the inventive apparatus is configured to request a transmission of the website from the web server, wherein the web server is configured to receive from the inventive apparatus a message used for requesting the transmission of the website from the web server, and wherein the web server is configured to send the website to the inventive apparatus, wherein the send/receive interface of the inventive apparatus is configured to receive the website from the web server, wherein an output module of the inventive apparatus is configured to output the website to a user, wherein the output module indicates to the user that there is the possibility to establish the communication connection, wherein the communication connection is an audio connection or an audio/video connection or a video connection, and wherein an input interface of the inventive apparatus is configured to receive an input of the user, by which the user indicates that the communication connection is to be established, wherein a processor module of the inventive apparatus is configured to generate a connection-establishment message that requests the establishment of the communication connection with a communication unit, wherein the send/receive interface of the inventive apparatus is configured to send the connection-establishment message to a switching center, wherein the send/receive interface of the inventive apparatus is configured to, after sending the connection-establishment message, send audio data or audio/video data or video data to the communication unit and to receive the same from the communication unit.

According to another embodiment, a switching center may include: a receive interface, and a send interface, wherein the receive interface is configured to receive a connection-establishment message from an apparatus, wherein the receive interface is configured to, after receiving the connection-establishment message of the apparatus, receive audio data or audio/video data or video data as first audio data or as first audio/video data or as first video data from the apparatus, wherein the send interface is configured to send the first audio data or the first audio/video data or the first video data received from the apparatus to a communication unit, wherein the receive interface is configured to, after receiving the connection-establishment message of the apparatus, receive from the apparatus further data that is different from the audio data or the audio/video data or the video data, wherein the send interface is configured to send the further data to the communication unit, wherein the receive interface is configured to receive second audio data or second audio/video data or second video data from the communication unit, wherein the send interface is configured to send the second audio data or the second audio/video data or the second video data received from the communication unit to the apparatus.

According to another embodiment, a web server for providing a website for a terminal device may include: a receive interface configured to receive from the terminal device a message used for requesting the transmission of the website from the web server, and a send interface configured to send the website and address information to the terminal device, wherein the address information includes at least two addresses, wherein each of the at least two addresses designates the address of a respective one of at least two communication units; or wherein the web server includes an analysis unit configured to select one of at least two addresses as the address information, wherein each of the at least two addresses designates the address of a respective one of at least two communication units, wherein the analysis unit is configured to select the address depending on the message received from the terminal device; or wherein the web server includes the analysis unit configured to select one of at least two addresses as the address information, wherein each of the at least two addresses designates the address of a respective one of at least two communication units, wherein the analysis unit is configured to select the one address depending on websites previously retrieved by the terminal device.

According to another embodiment, a method may include: receiving a connection-establishment message from an apparatus by a switching center, after receiving the connection-establishment message from the apparatus, receiving audio data or audio/video data or video data as first audio data or as first audio/video data or as first video data from the apparatus by the switching center, sending the received first audio data or first audio/video data or first video data from the switching center to a communication unit, after receiving the connection-establishment message from the apparatus, receiving further data from the apparatus by the switching center, which differs from the audio data or the audio/video data or the video data, sending the further data from the switching center to the communication unit, receiving second audio data or second audio/video data or second video data from the communication unit by the switching center, sending the received second audio data or second audio/video data or second video data from the switching center to the apparatus

According to another embodiment, a method for providing a website for a terminal device may include: receiving from the terminal device a message used for requesting the transmission of the website from the web server, and sending the website and address information to the terminal device, wherein the address information includes at least two addresses, wherein each of the at least two addresses designates the address of a respective one of at least two communication units; or wherein one of the at least two addresses is selected as the address information, wherein each of the at least two addresses designates the address of a respective one of the at least two communication units, wherein the one address is selected depending on the message received by the terminal device, or wherein one of the at least two addresses is selected as the address information, wherein each of the at least two addresses designates the address of the respective one of the at least two communication units, wherein the one address is selected depending on websites previously received by the terminal device.

Another embodiment may have a non-transitory digital storage medium having a computer program stored thereon to perform the method for retrieving a website from a web server and for establishing a communication connection, including: requesting the transmission of the website from the web server and receiving the website from the web server, outputting the website for a user, wherein the output module further indicates to the user that there is the possibility to establish the communication connection, wherein the communication connection is an audio connection or an audio/video connection or a video connection, and receiving an input of the user, by which the user indicates that the communication connection is to be established, generating a connection-establishment message that requests the establishment of the communication connection with a communication unit, wherein the connection-establishment message includes the address information indicating the address of the communication unit, sending the connection-establishment message to a switching center, after sending the connection-establishment message, sending audio data or audio/video data or video data to the communication unit and receiving audio data or audio/video data or video data from the communication unit, when said computer program is run by a computer.

Another embodiment may have a non-transitory digital storage medium having a computer program stored thereon to perform the method, including: receiving a connection-establishment message from an apparatus by a switching center, after receiving the connection-establishment message from the apparatus, receiving audio data or audio/video data or video data as first audio data or as first audio/video data or as first video data from the apparatus by the switching center, sending the received first audio data or first audio/video data or first video data from the switching center to a communication unit, after receiving the connection-establishment message from the apparatus, receiving further data from the apparatus by the switching center, which differs from the audio data or the audio/video data or the video data, sending the further data from the switching center to the communication unit, receiving second audio data or second audio/video data or second video data from the communication unit by the switching center, sending the received second audio data or second audio/video data or second video data from the switching center to the apparatus, when said computer program is run by a computer.

Another embodiment may have a non-transitory digital storage medium having a computer program stored thereon to perform the method for providing a website for a terminal device, including: receiving from the terminal device a message used for requesting the transmission of the website from the web server, and sending the website and address information to the terminal device, wherein the address information includes at least two addresses, wherein each of the at least two addresses designates the address of a respective one of at least two communication units; or wherein one of the at least two addresses is selected as the address information, wherein each of the at least two addresses designates the address of a respective one of the at least two communication units, wherein the one address is selected depending on the message received by the terminal device, or wherein one of the at least two addresses is selected as the address information, wherein each of the at least two addresses designates the address of the respective one of the at least two communication units, wherein the one address is selected depending on websites previously received by the terminal device, when said computer program is run by a computer.

An apparatus for retrieving a website from a web server and for establishing a communication connection is provided. The apparatus includes a send/receive interface configured to request from the web server a transmission of the website, and configured to receive the website from the web server. Furthermore, the apparatus includes an output module configured to output the website to a user, wherein the output module further indicates to the user that there is the possibility of establishing the communication connection, the communication connection being an audio connection or an audio/video connection or a video connection. Furthermore, the apparatus includes an input interface configured to receive an input of the user, by means of which the user indicates that the communication connection is to be established. Furthermore, the apparatus includes a processor module configured to generate a connection-establishment message that requests the establishment of the communication connection with the communication unit. The send/receive interface is configured to send the connection-establishment message to a switching center. Furthermore, the send/receive interface is configured to, after sending the connection-establishment message, send audio data or audio/video data or video data to the communication unit and receive the same from the communication unit.

In an embodiment, the send/receive interface is configured to, after sending the connection-establishment message, send audio data or audio/video data or video data to the communication unit via the switching center and to receive the same from the communication unit via the switching center.

In a special embodiment, the send/receive interface is configured to send to the switching center identification information that identifies the communication unit or identifies a group of communication units, wherein the group of communication units includes the communication unit.

In another embodiment, the send/receive interface is configured to receive address information from the web server, the address information indicating an address of the communication unit, wherein the connection-establishment message includes the address information indicating the address of the communication unit.

In certain embodiments, further, or different, data may be exchanged. For example, payment data or data for exchanging dynamic website content may be exchanged.

Furthermore, a switching center is provided. The switching center includes a receive interface and a send interface. The receive interface is configured to receive a connection-establishment message from an apparatus, wherein the receive interface is configured to, after receiving the connection-establishment message of the apparatus, receive first audio data or first audio/video data or first video data from the apparatus, and wherein the send interface is configured to send the first audio data or first audio/video data or first video data received from the apparatus to a communication unit. Furthermore, the receive interface is configured to, after receiving the connection-establishment message of the apparatus, obtain from the apparatus further data which differs from the audio data or the audio/video data or the video data, wherein the send interface is configured to send the further data to the communication unit. Furthermore, the receive interface is configured to receive second audio data or second audio/video data or second video data from the communication unit, wherein the send interface is configured to send to the apparatus the second audio data or second audio/video data or second video data received from the communication unit.

Furthermore, a web server for providing a website for a terminal device is provided. The web server includes a receive interface configured to receive from the terminal device a message used for requesting the transmission of the website from the web server. Furthermore, the web server includes a send interface configured to send the website and address information to the terminal device. The address information includes at least two addresses, wherein each of the at least two addresses designates the address of a respective one of at least two communication units.

Furthermore, a web server for providing a website for a terminal device is provided. The web server includes a receive interface configured to receive from the terminal device a message used for requesting the transmission of the website from the web server. Furthermore, the web server includes a send interface configured to send the website and address information to the terminal device. Furthermore, the web server includes an analysis unit configured to select one of at least two addresses as the address information, wherein each of the at least two addresses designates the address of a respective one of at least two communication units, wherein the analysis unit is configured to select the one address depending on the message received from the terminal device.

Furthermore, a web server for providing a website for a terminal device is provided. The web server includes a receive interface configured to receive from the terminal device a message used for requesting the transmission of the website from the web server. Furthermore, the web server includes a send interface configured to send the website and address information to the terminal device. Furthermore, the web server includes an analysis unit configured to select one of at least two addresses as the address information, wherein each of the at least two addresses designates the address of a respective one of at least two communication units, wherein the analysis unit is configured to select the one address depending on websites previously retrieved by the terminal device.

Furthermore, a method for retrieving a website from a web server and for establishing a communication connection is provided. The method includes:
Requesting from the web server the transmission of the website and receiving the website from the web server.
Outputting the website for a user, wherein the output module further indicates to the user that there is the possibility to establish a communication connection, the communication connection being an audio connection or an audio/video connection or a video connection.
Receiving an input of the user, by means of which the user indicates that the communication connection is to be established.
Generating a connection-establishment message that requests the establishment of the communication connection with a communication unit.
Sending the connection-establishment message to a switching center. And:
After sending the connection-establishment message, sending audio data or audio/video data or video data to the communication unit and receiving audio data or audio/video data or video data from the communication unit.

In addition, a further method is provided, the method including:
Receiving through a switching center a connection-establishment message from an apparatus.
After receiving the connection-establishment message from the apparatus, receiving through the switching center first audio data or first audio/video data or first video data from the apparatus.
Sending the received first audio data or first audio/video data or first video data from the switching center to a communication unit.
After receiving the connection-establishment message from the apparatus, receiving through the switching center further data from the apparatus, which differs from the audio data or the audio/video data or the video data,
sending the further data from the switching center to the communication unit,
receiving through the switching center second audio data or second audio/video data or second video data from the communication unit,
sending the received second audio data or second audio/video data or second video data from the switching center to the apparatus.

Furthermore, a method for providing a website for a terminal device is provided. The method includes:
Receiving from the terminal device a message used for requesting the transmission of the website from the web server. And:
Sending the website and address information to the terminal device.

The address information includes at least two addresses, wherein each of the at least two addresses designates the address of a respective one of at least two communication units.

Furthermore, a method for providing a website for a terminal device is provided. The method includes
Receiving from the terminal device a message used for requesting the transmission of the website from the web server. And:
Sending the website and address information to the terminal device.

One of at least two addresses is selected as the address information, wherein each of the at least two addresses designates the address of a respective one of at least two communication units, wherein the one address is selected depending on the message received from the terminal device.

Furthermore, a method for providing a website for a terminal device is provided. The method includes:
Receiving from the terminal device a message used for requesting the transmission of the website from the web server. And:
Sending the website and address information to the terminal device.

One of at least two addresses is selected as the address information, wherein each of the at least two addresses designates the address of a respective one of at least two communication units, wherein the one address is selected depending on websites previously retrieved by the terminal device.

Furthermore, provided are computer programs for executing a respective one of the described methods, when the respective computer program is running on a computer or a signal processor.

### BRIEF DESCRIPTION OF THE DRAWINGS

Embodiments of the present invention will be detailed subsequently referring to the appended drawings, in which:

FIG. 1 shows an apparatus for retrieving a website from a web server and for establishing a communication connection according to an embodiment. Furthermore, FIG. 1 shows a system according to an embodiment.

FIG. 1a shows an apparatus for retrieving a website from a web server and for establishing a communication connection according to a further embodiment. FIG. 1a further shows a system according to a further embodiment.

FIG. 1b shows an apparatus according to an embodiment, wherein the apparatus interacts with an authorization server and a payment service server. FIG. 1b further shows a system according to a further embodiment.

FIG. 1c shows an apparatus according to an embodiment, wherein the apparatus interacts with a STUN server. FIG. 1c further shows a system according to a further embodiment.

FIG. 1d shows a web server for providing a website for a terminal device according to a first embodiment.

FIG. 1e shows a web server for providing a website for a terminal device according to a second embodiment.

FIG. 1f shows a web server for providing a website for a terminal device according to a third embodiment.

FIG. 1g shows an apparatus for retrieving a website from a web server and for establishing a communication connection according to a further embodiment.

FIG. 1g further shows a system according to a further embodiment, wherein the communication between the apparatus and the communication unit is carried out via the switching center.

FIG. 1h shows an apparatus according to an embodiment, wherein the apparatus interacts with an authorization server and a payment service server. FIG. 1h further shows a system according to a further embodiment, wherein the communication between the apparatus and the communication unit is carried out via the switching center.

FIG. 1i shows an apparatus according to an embodiment, wherein the apparatus interacts with a STUN server. FIG. 1i further shows a system according to a further embodiment, wherein the communication between the apparatus and the communication unit is carried out via the switching center.

FIG. 2 shows an example of such a dial app.

FIG. 3 shows an example of a website that is provided in response to a search request of an internet search engine.

FIG. 4a, 4b show special embodiments, wherein a click on a link of a button triggers a series of actions according to embodiments.

FIG. 5 shows an embodiment that is implemented for the interaction with a search engine.

FIG. 6 shows a flow diagram according to an embodiment which realizes payment during the connection. And:

FIG. 7a, 7b show flow diagrams over time according to an embodiment which realizes payment during the connection.

FIG. 8a shows a website that is displayed to a user by an apparatus for retrieving a website.

FIG. 8b shows a pop-up window for establishing a communication connection, which is displayed to a user by an apparatus for retrieving a website.

FIG. 8c shows an output that is displayed to a user of a communication unit.

FIG. 8d shows a pop-up window that is displayed to a user by an apparatus for retrieving a website when a communication connection has been established by means of the “Join with FB” variation.

FIG. 8e shows a pop-up window that is displayed to a user by an apparatus for retrieving a website when a communication connection has been established by means of the “Join local” variation.

FIG. 9a shows two websites that are displayed to a user by an apparatus for retrieving a website.

FIG. 9b shows one of the websites of FIG. 9a, as displayed on a communication unit.

FIG. 9c shows a flow diagram of a special embodiment.

FIG. 10 shows a switching center according to an embodiment.

### DETAILED DESCRIPTION OF THE INVENTION

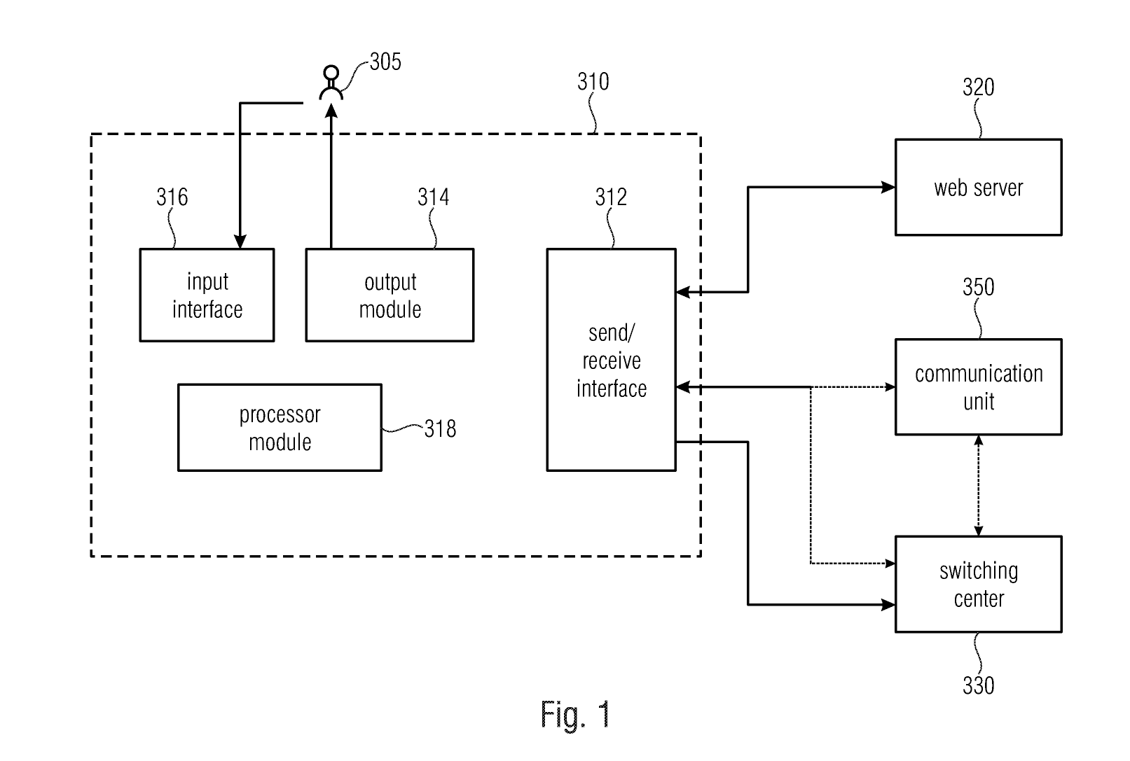

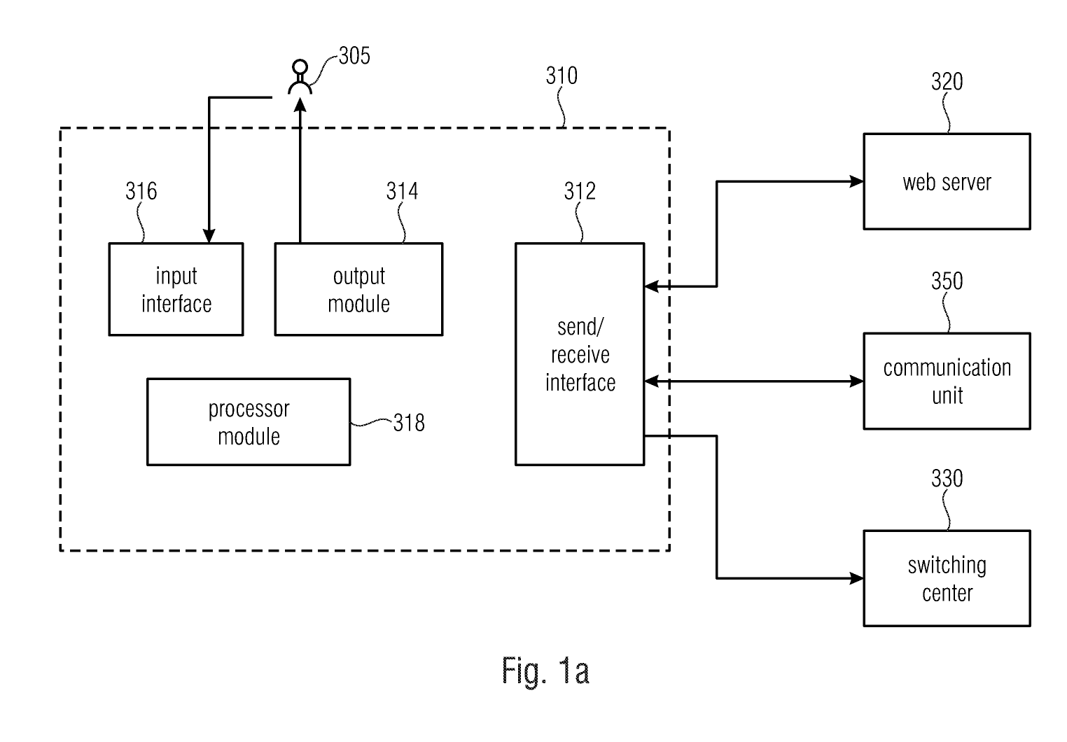

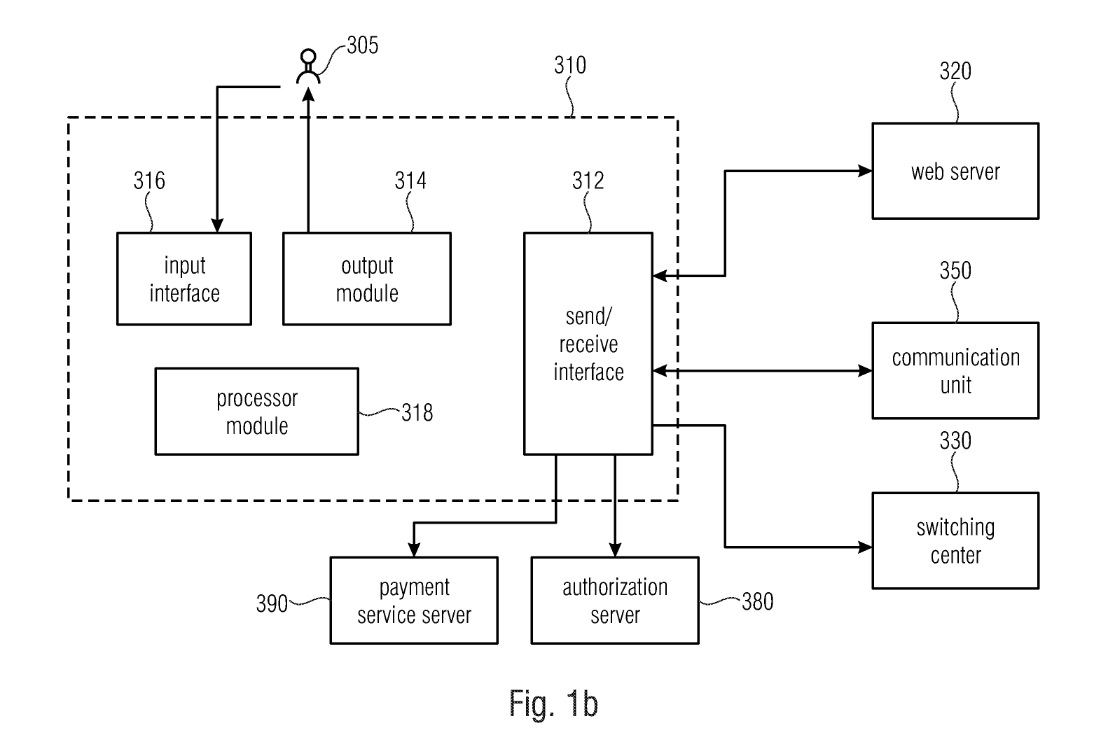

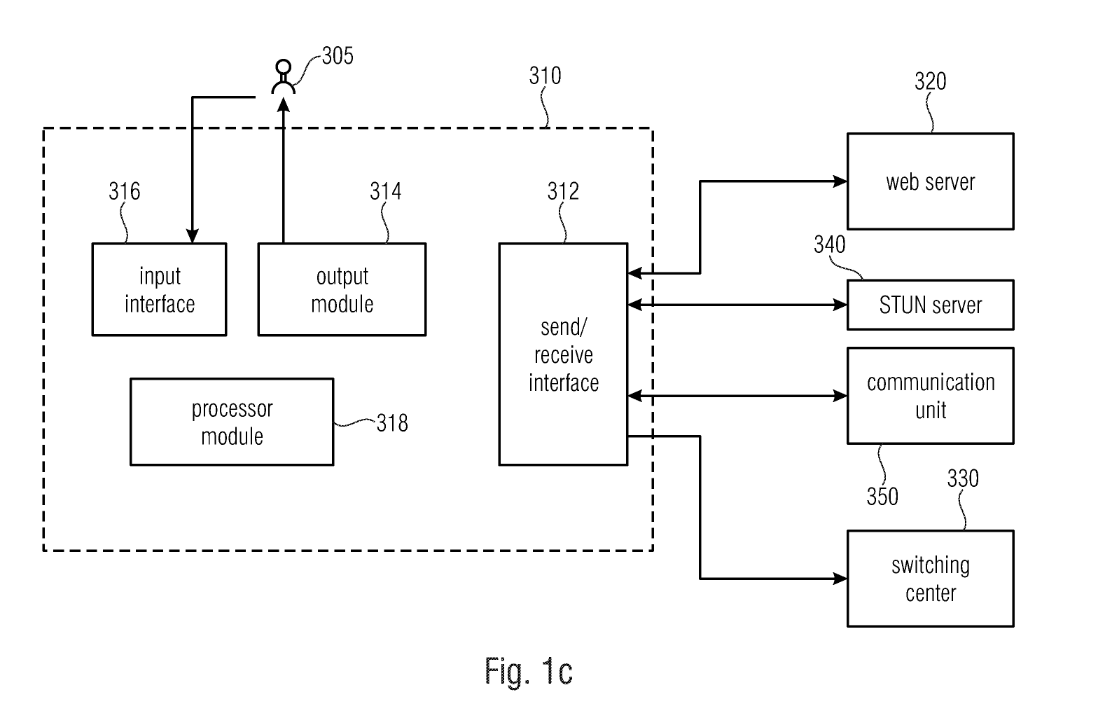

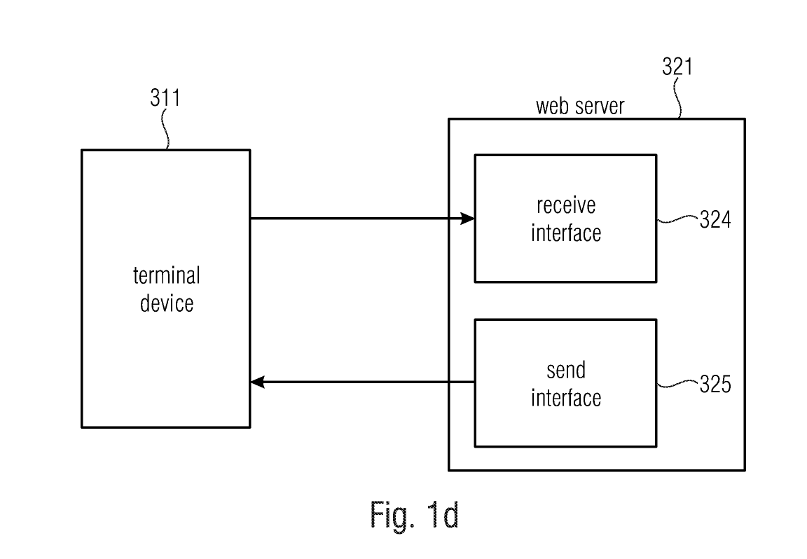

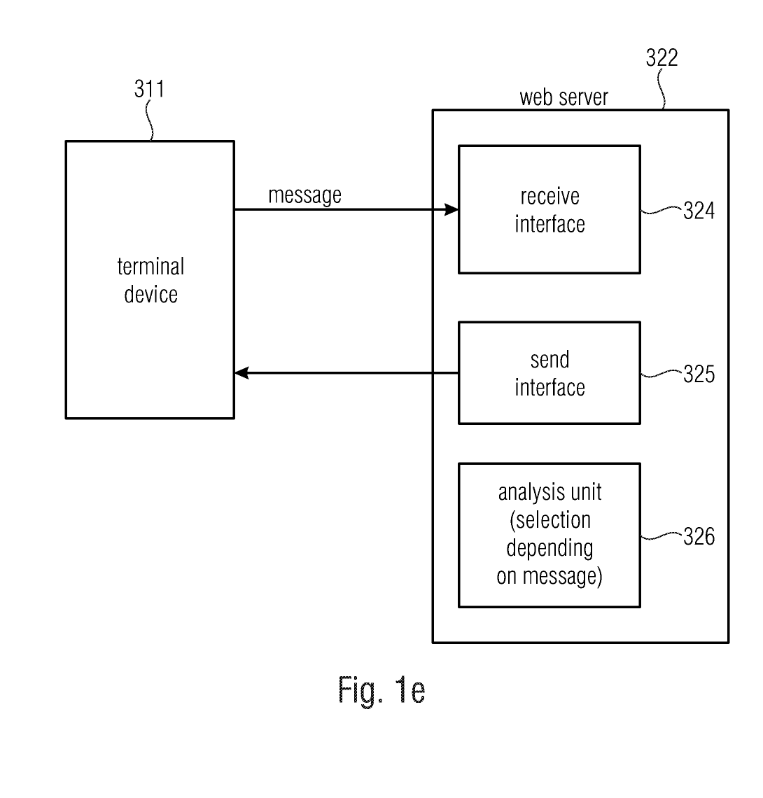

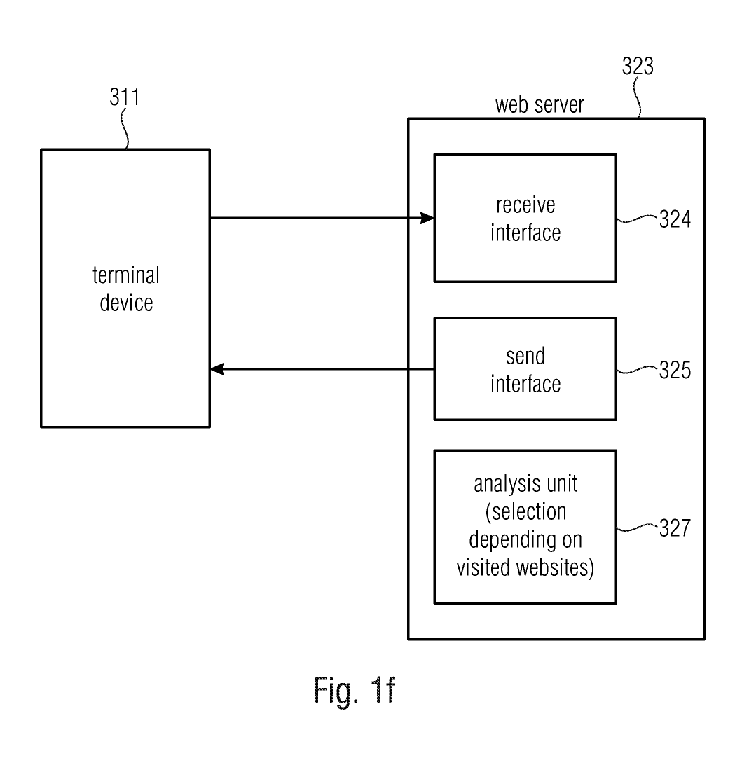

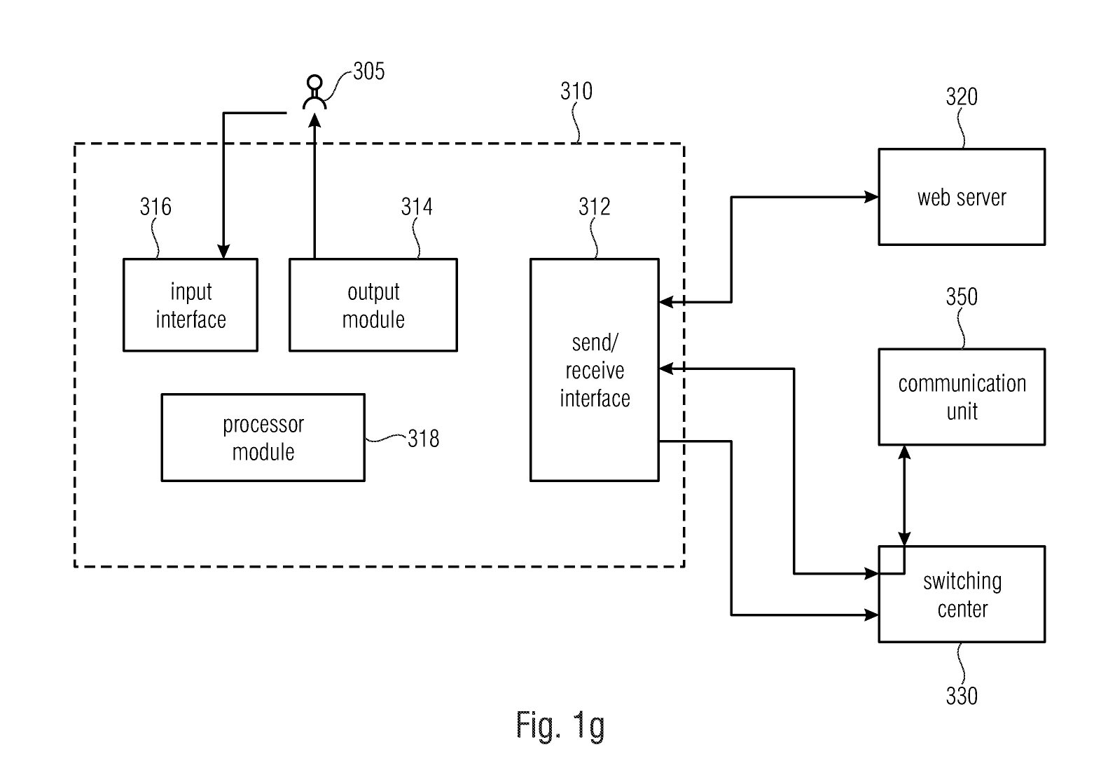

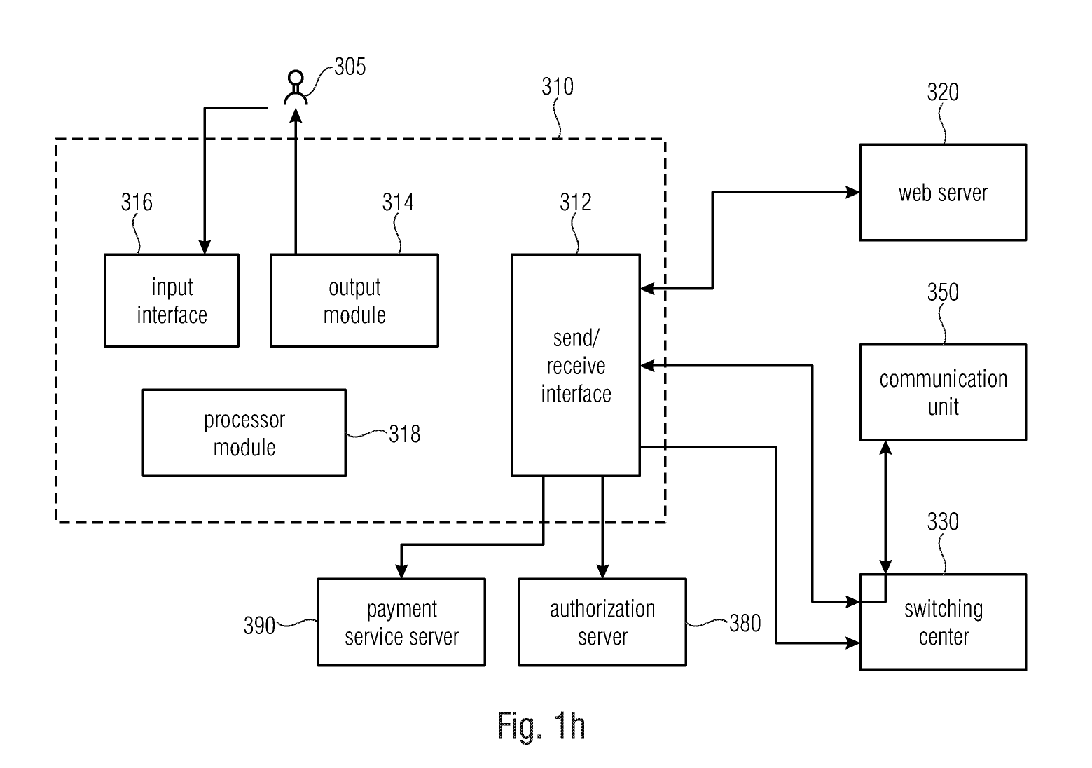

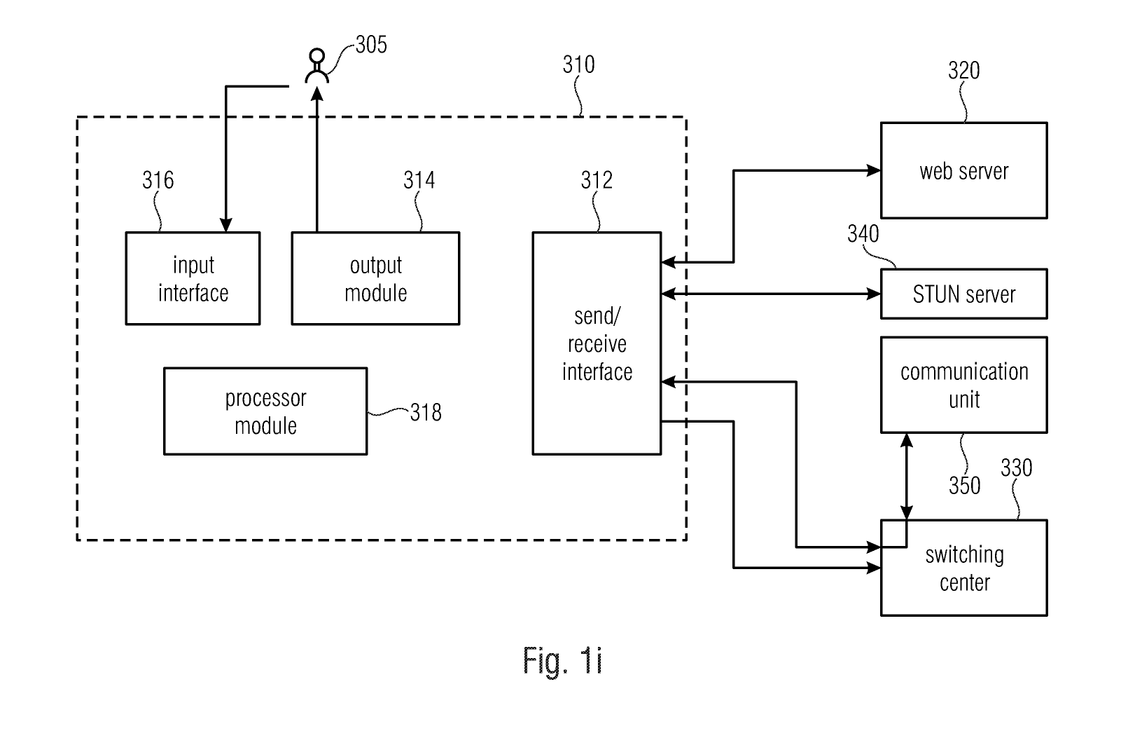

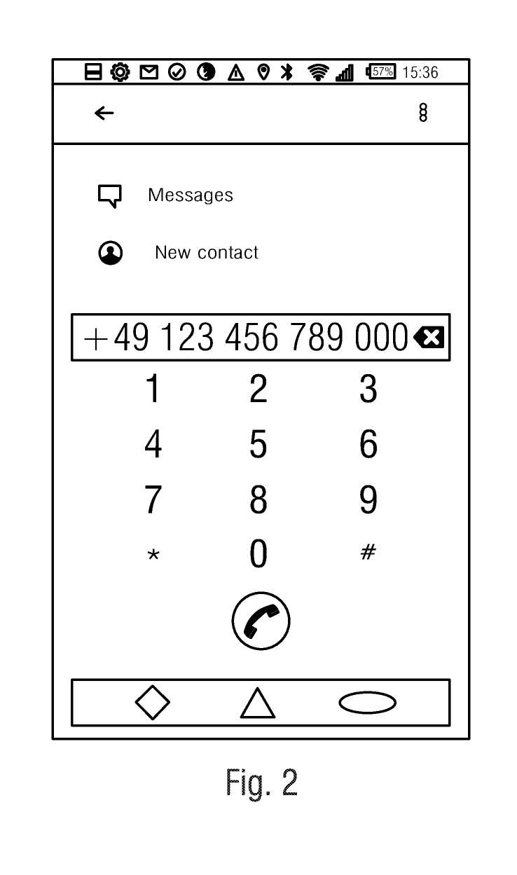

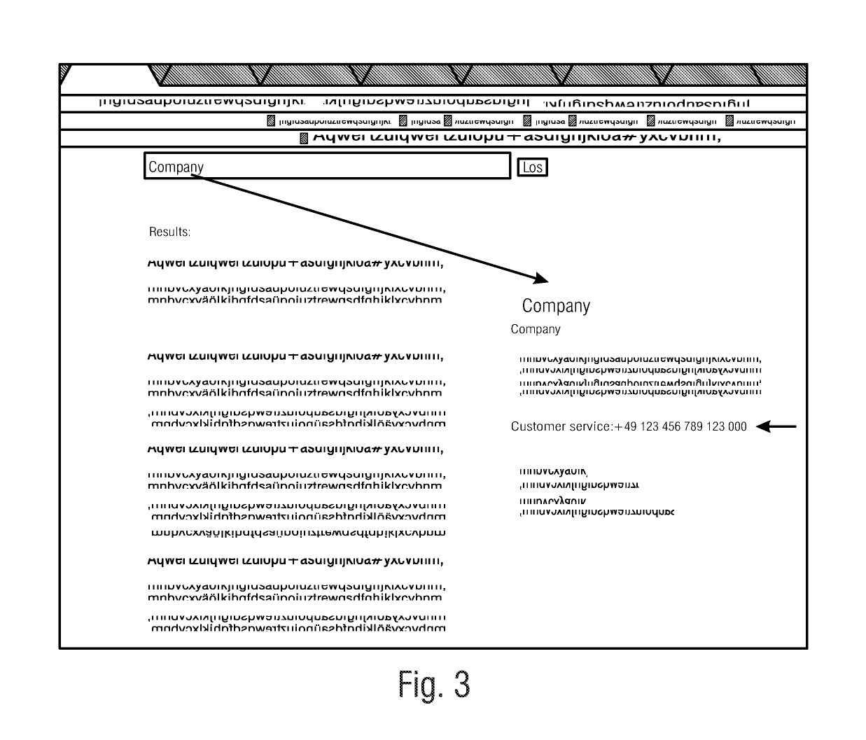

FIG. 1 shows an apparatus 310 for retrieving a website from a web server 320 and for establishing a communication connection according to an embodiment.

The apparatus 310 includes a send/receive interface 312 configured to request from the web server 320 a transmission of the website and configured to receive the website from the web server 320.

Furthermore, the apparatus 310 includes an output module 314 configured to output the website to a user 305, wherein the output module 314 further indicates to the user 305 that there is the possibility of establishing the communication connection, the communication connection being an audio connection or an audio/video connection or a video connection.

Furthermore, the apparatus 310 includes an input interface 316 configured to receive an input of the user 305, by means of which the user 305 indicates that the communication connection is to be established.

Furthermore, the apparatus 310 includes a processor module 318 configured to generate a connection-establishment message that requests the establishment of the communication connection with a communication unit 350.

The send/receive interface 312 is configured to send the connection-establishment message to a switching center 330. Furthermore, the send/receive interface 312 is configured to, after sending the connection-establishment message, send audio data or audio/video data or video data to the communication unit 350 and to receive the same from the communication unit 350.

In an embodiment, the send/receive interface 312 is configured to receive address information from the web server 320, wherein the address information indicates an address of the communication unit 350, wherein the connection-establishment message includes the address information indicating the address of the communication unit 350. This embodiment is shown in FIGS. 1a, 1b, and 1c.

In another embodiment, the send/receive interface 312 is configured to, after sending the connection-establishment message, send audio data or audio/video data or video data to the communication unit 350 via the switching center 330 and to receive the same from the communication unit 350 via the switching center 330. This embodiment in which the communication between the apparatus 310 and the communication unit 350 is carried out via the switching center 330 is shown in FIGS. 1g, 1 h, and 1i.

In a special embodiment, the send/receive interface 312 is configured to send to the switching center 330 identification information that identifies the communication unit 350 or identifies a group of communication units, wherein the group of communication units includes the communication unit 350.

For example, the identification information transferred by the apparatus 310 may be a customer ID of the web server operator at the switching center 330. Then, based on the customer ID transferred by the apparatus 310, the switching center 330 may determine with which communication unit 350 the connection is established. Thus, for example, exactly one communication unit 350 may be possible for one customer ID.

Alternatively, it may be possible to assign several communication units 350 to one customer ID of the web server operator. For example, the web server operator may run a call center, wherein each call center employee has a communication unit 350 that may each be known to the switching center 330. In this case, the switching center 330 may then display to each of the communication units 350 of each call center employee the connection request of the apparatus 310. For example, this may be made noticeable at each of the communication units 350 via a ring tone and/or an optical signal. Then, if one of the call center employees accepts the connection request at his/her communication unit, the switching center 330 routes the connection data incoming from the apparatus only to this communication unit 350.

In an embodiment, the processor module 318 may be configured to, e.g., generate the connection-establishment message used for requesting the establishment of the communication connection with the communication unit 350 such that the connection-establishment message does not contain any information that identifies the user 305 of the apparatus 310.

According to an embodiment, the send/receive interface 312 may be configured to, e.g., send the audio data or the audio/video data or the video data to the communication unit 350; 450; 550 together with an identifier so that the identifier indicates that the audio data or the audio/video data or the video data was sent by the apparatus 310; 410; 510.

For example, in an embodiment, the identifier does not contain any information that identifies the user 305; 405; 505 of the apparatus 310; 410; 510.

According to an embodiment, the send/receive interface 312 may be configured to, e.g., after sending the connection-establishment message, obtain the identifier from the switching center 330; 440; 530.

In an embodiment, for example, the identifier may be a globally unique identifier (GUID).

According to an embodiment, the processor module 318 may be implemented to, e.g., generate one or several communication connection messages that depend on the communication connection, but that differ from the sent or received audio data or audio/video data or video data, wherein the send/receive interface 312 may be configured to send the one or several communication connection messages to a connection event server 560 together with the identifier. With this, it may be indicated that the one or several communication connection messages refer to the apparatus 310; 410; 510 (and to the established communication connection).

In an embodiment, the send/receive interface 312 may be configured to send to the switching center 330 a registration message used for requesting a registration, wherein the registration message does not include any information that identifies the user 305 of the apparatus 310. In this case, the send/receive interface 312 may be configured to, e.g., obtain a response message from the switching center 330, wherein the response message includes a registration identifier. Furthermore, the processor module 318 may be configured to, e.g., generate the connection-establishment message used for requesting the establishment of the communication connection with the communication unit 350 such that the connection-establishment message includes the registration identifier.

According to an embodiment, the processor module 318 may be configured to, e.g., generate the connection-establishment message used for requesting the establishment of the communication connection with the communication unit 350 such that the connection-establishment message includes a SIP address as the address information indicating the address of the communication unit 350.

In an embodiment, the send/receive interface 312 may be configured to, e.g., send the audio data or the audio/video data or the video data to the communication unit 350 using WebRTC® or to receive the same from the communication unit 350.

According to an embodiment, the output module 314 may include a display, wherein the output module 314 may be configured to output the website on the display. For example, the output module 314 may indicate to the user 305 that there is the possibility to establish the communication connection by displaying a clickable link or a clickable button.

In an embodiment, upon clicking the clickable link or the clickable button, the processor module 318 may be configured to generate the connection-establishment message, and the send/receive interface 312 may be configured to, e.g. send the connection-establishment message to the switching center 330 without a further interaction with the user 305.

According to an embodiment, upon clicking the clickable link or the clickable button, the processor module 318 may be configured to, e.g., generate the connection-establishment message. In this case, the send/receive interface 312 may be configured to send the connection-establishment message to the switching center 330 without a graphical display overlapping on the website displayed on the display.

In an embodiment, the send/receive interface 312 may be configured to, e.g., after sending the connection-establishment message, send the audio data to the communication unit 350 and to receive the same from the communication unit 350 without the website output on the display being entirely or partially overlapped by a graphical display.

According to an embodiment, the output module 314 may be configured to, e.g., display the video data received from the communication unit 350 in a website or integrated into a website that is displayed on the display.

In an embodiment, the send/receive interface 312 may further be configured to, e.g., after the audio data or the audio/video data or the video data has been sent to the communication unit 350 or has been received by the communication unit 350, obtain a payment request message from the communication unit 350. In this case, the output module 314 may be configured to, e.g. output on the display a further website that displays the payment form, wherein payment data may be input into the payment form.

FIG. 1b shows an apparatus 310 according to an embodiment, wherein the apparatus 310 interacts with an authorization server 380 and a payment service server 390. See also FIG. 1h.

For example, in an embodiment, the payment form may comprise input fields for authorization data, wherein the send/receive interface 312 may be configured to, e.g., send to an authorization server 380 the authorization data that was input into the input fields of the payment form by the user 305.

According to an embodiment, the output module 314 may be configured to, e.g. output the further website on the display that displays the payment form so that a user name and a password are requested by the payment form as the authorization data.

In an embodiment, the send/receive interface 312 may be configured to, e.g., send to a payment service server 390 input data that was input into the input form and that requests a payment.

According to an embodiment, the send/receive interface 312 may be configured to, e.g., after the send/receive interface 312 has sent the payment data to the payment service server 390, send further audio data or audio/video data or video data to the communication unit 350 or receive the same from the communication unit 350.

In an embodiment, the send/receive interface 312 may be configured to, e.g., request from the web server 320 the transmission of the website, wherein the web server 320 may be a web server of a search engine. In this case, the send/receive interface 312 may be configured to, e.g., together with the request for transferring the website, send one or several search terms of a search request, wherein the website may include a search result of the search request with the one or several search terms.

According to an embodiment, the processor module 318 may be implemented to, e.g., generate one or several communication connection messages that depend on the communication connection, but that differ from the sent or received audio data or audio/video data or video data. In this case, the receive interface may be configured to, e.g., send the one or several communication connection messages to a connection event server.

FIG. 1c shows an apparatus 310 according to an embodiment, wherein the apparatus 310 interacts with a STUN server 340. See also FIG. 1i.

In an embodiment, the send/receive interface 312 may be configured to, e.g., send a request message to a STUN server 340. In this case, the send/receive interface 312 may be configured to, e.g., obtain from the STUN server 340 a response message having connection information. Furthermore, the send/receive interface 312 may be configured to, e.g., perform sending the audio data or audio/video data or video data to the communication unit 350 based on the connection information from the response message of the STUN server 340.

FIG. 1d shows a web server 321 for providing a website for a terminal device 311 according to an embodiment.

The web server 321 includes a receive interface 324f configured to receive from the terminal device 311 a message used for requesting the transmission of the website from the web server 321.

Furthermore, the web server 321 includes a send interface 325 configured to send the website and address information to the terminal device 311. The address information includes at least two addresses, wherein each of the at least two addresses designates the address of a respective one of at least two communication units.

The terminal device 311 may be one of the above-described apparatuses 310.

FIG. 1e shows a web server 322 for providing a website for a terminal device 311 according to a further embodiment. The web server 322 includes a receive interface 324 configured to receive from the terminal device 311 a message used for requesting the transmission of the website from the web server 322. Furthermore, the web server 322 includes a send interface 325 configured to send the website and the address information to the terminal device 311.

Furthermore, the web server 322 includes an analysis unit 326 configured to select one of at least two addresses as the address information, wherein each of the at least two addresses designates the address of a respective one of at least two communication units, wherein the analysis unit 326 is configured to select an address depending on the message received from the terminal device 311. The terminal device 311 may be one of the above-described apparatuses 310.

In an embodiment, e.g., the web server 322 may be the web server 322 of a search engine. For example, the message from the terminal device 311 may further include one or several search terms. In this case, the analysis unit 326 may be configured to, e.g., select an address depending on the one or several search terms.

FIG. 1f shows a web server 323 for providing a website for a terminal device 311 according to a further embodiment. The web server 323 includes a receive interface 324 configured to receive from the terminal device 311 a message used for requesting the transmission of the website from the web server 323. Furthermore, the web server 323 includes a send interface 325 configured to send the website and address information to the terminal device 311.

Furthermore, the web server 323 includes an analysis unit 327 configured to select one of at least two addresses as the address information, wherein each of the at least two addresses designates the address of a respective one of at least two communication units, wherein the analysis unit 327 may be configured to select an address depending on websites previously retrieved by the terminal device 311. The terminal device 311 may be one of the above-described apparatuses 310.

According to an embodiment, e.g., each address of the at least two addresses sent by the above web servers 320; 321; 322; 323 may be a SIP address.

Furthermore, a system for retrieving a website, for providing the website and for establishing a communication connection is provided.

The system includes an apparatus 310 according to one of the above embodiments and a web server 320. A send/receive interface 312 of the apparatus 310 is configured to request a transmission of the website from the web server 320. For example, the components 310 and 320 of such a system can be seen in FIG. 1, FIG. 1a, FIGS. 1b and 1n FIGS. 1c and 1n FIG. 1g, FIG. 1h and FIG. 1i.

For example, the web server 320 may be a web server 320 of FIG. 1a or of FIG. 1b or of FIG. 1c.

The web server 320 is configured to receive from the apparatus 310 a message used for requesting the transmission of the website from the web server 320. Furthermore, the web server 320 is configured to send the website and address information to the apparatus 310, wherein the address information includes an address of a communication unit 350.

The send/receive interface 312 of the apparatus 310 is configured to receive the website and the address information from the web server 320.

An output module 314 of the apparatus 310 is configured to output the website to a user 305, wherein the output module 314 further indicates to the user 305 that there is the possibility to establish the communication connection, wherein the communication connection is an audio connection or an audio/video connection or a video connection.

Furthermore, an input interface 316 of the apparatus 310 is configured to receive an input of the user 305, by means of which the user 305 indicates that the communication connection is to be established.

Furthermore, a processor module 318 of the apparatus 310 is configured to generate a connection-establishment message that requests the establishment of the communication connection with the communication unit 350, wherein the connection-establishment message includes the address information indicating the address of the communication unit 350.

The send/receive interface 312 of the apparatus 310 is configured to send the connection-establishment message to a switching center 330. Furthermore, the send/receive interface 312 of the apparatus 310 is configured to, after sending the connection-establishment message, send audio data or audio/video data or video data to the communication unit 350 and to receive the same from the communication unit 350.

According to an embodiment, the system may further include the communication unit 350, wherein the communication unit 350 may be configured to send audio data or audio/video data or video data to the apparatus 310 and to receive the same from the apparatus 310.

In an embodiment, the system may further include the switching center 330; 430; 530.

The send/receive interface 312 of the apparatus 310; 410; 510 may be configured to send a connection-establishment message to the switching center 330; 440; 530. The send/receive interface 312 may be configured to, e.g., after sending the connection-establishment message, obtain an identifier from the switching center 330; 440; 530. Furthermore, the send/receive interface 312 may be configured to send the audio data or the audio/video data or the video data to the communication unit 350; 450; 550 together with an identifier so that the identifier indicates that the audio data or the audio/video data or the video data were sent from the apparatus 310; 410; 510.

For example, according to an embodiment, the identifier does not include any information identifying the user (305; 405; 505) of the apparatus 310; 410; 510.

In an embodiment, the identifier may be a globally unique identifier (GUID).

In an embodiment, e.g., the system may further comprise an authorization server 380. For example, the additional component 380 of such a system can be seen in FIG. 1b.

The send/receive interface 312 of the apparatus 310 may further be configured to, after the audio data or the audio/video data or the video data has been sent to the communication unit 350 and has been received from the communication unit 350, obtain from the communication unit 350 a payment request message. The output module 314 of the apparatus 310 may further be configured to output on the display a further website displaying a payment form, wherein payment data may be input into the payment form, wherein the payment form may comprise input fields for authorization data. Furthermore, the send/receive interface 312 of the apparatus 310 may be configured to, e.g., send to the authorization server 380 the authorization data input into the input fields of the payment form by the user 305, wherein the output module 314 of the apparatus 310 may be configured to output on the display the further website displaying the payment form so that a user name and a password may be requested by the payment form as the authorization data.

According to an embodiment, e.g., the system may further include a payment service server 390. For example, the additional component 390 of such a system can be seen in FIG. 1b.

In this case, the send/receive interface 312 may be configured to send to the payment service server 390 payment data that was input into the input form and that requests a payment, and wherein the payment service server 390 may be configured to process the payment data.

In an embodiment, the send/receive interface 312 of the apparatus 310 may be configured to, e.g., after the send/receive interface 312 has sent the payment data to the payment service server 390, send further audio data or audio/video data or video data to the communication unit 350 and to receive the same from the communication unit 350.

In special embodiments, the web server 320 of the systems described herein may be implemented, e.g., as a web server 321 of FIG. 1d or as a web server 322 of FIG. 1e or as a web server 323 of FIG. 1f.

In the following, one of the embodiments of the invention is described. Embodiments of the invention may be referred to as “1-Click-Call”, since, in embodiments, a communication connection is triggered via one click by means of an input device, e.g., a click onto a link or a button on a website displayed by a web browser; or via a click onto a link or a button on a website displayed by a web browser by means of touching the display surface of a smartphone with a finger. All known technical possibilities for clicking on, or touching, a link or a button are possible.

Special embodiments may be carried out in a classic web browser, e.g., as follows: The user looks at a website (e.g. an HTML document) within his/her web browser. A button or a link is displayed in a special area. (In the following, if reference is made to a link, this also includes technical realizations that display a button). The displayed link (or button) may be clicked.

Other embodiments refer to other possibilities of user clients, or terminal devices. In this case, embodiments also realize audio devices having a cloud connection which are marketed as digital assistants (e.g., see:

[17a]: https://de.wikipedia.org/wiki/Amazon_Echo or

[17b]: https://en.wikipedia.org/wiki/Amazon_Echo).

Such an approach may basically be compared to the speech/voice assistance in smartphones (“OK Google” ® or Siri®). Such assistance may also be used to establish an audio connection. The click is simply replaced by an audio command.

In telephony, a distinction is made between the A-participant and the B-participant. The A-participant is the user establishing the connection. In a dial-connection, the B-participant (called party) is the participant dialed by the A-participant. Accordingly, the A-leg is the distance from the A-participant to the telephone system (or to a switching center). The B-leg is the distance from the B-participant to the telephone system (or to the switching center), see:

[18]: https://de.wikipedia.org/wiki/Teilnehmer (Kommunikationssystem).

In embodiments of the invention, the destination of the connection is fixedly configured. In such embodiments, the B-leg is also fixedly configured. Thus, the A-participant (the user) may not establish a connection to a random destination. In an embodiment, e.g., a fixed destination is firmly predetermined. In another embodiment, one or several fixed destinations to which the connection is to be established are predetermined by the B-participant in a previous configuration process. Figuratively speaking, the speed-dial button, as it was known in the past, has been extended in its functionality. Now, it is a speed-dial button of an anonymous user for a previously fixed destination (a previously fixed end point).

A destination, also called an end point, may be various things, e.g., a landline telephone connection and/or a mobile telephone connection (mobile telephone/smartphone) and/or a SIP client (e.g. as a smartphone app or as desktop software) and/or a Skype client (e.g. as a smartphone app or as desktop software) and/or a browser in connection with a special website which turns the browser into a software device by means of WebRTC®.

In some embodiments, upon clicking the link, e.g., a connection a switching center is established. The user initially establishing the connection is referred to as A-participant. In contrast to previous telephony or connection concepts, the A-participant (the user initially establishing the connection) is completely anonymous. The SIP client is registered with the telephone system; however, only an anonymous connection ID is used here. Anonymity ensures, e.g., that a user does not have to register for this process beforehand.

Rather, every user may use this process as long as the technical requirements are met.

The anonymity of the connection establishment is an essential difference to the conventional technology.

The comparison with the speed-dial key of a telephone is used again: the connection to a stored number is established by the telephone with just a keystroke. A big difference to the speed-dial key of a telephone, however, is that the A-participant is anonymous in embodiments of the invention.

Thus, in embodiments, registration or the like is not required for the initial use. The A-participant, or the connection, is initially anonymous. For example, the end point may be a browser, but may also be another technical device such as “Amazon Echo” @.

According to embodiments, the type of the connection may purely be an audio connection an audio/video connection or a video connection.

In special embodiments, all connections may optionally include an additional data channel for transferring further data of any content.

According to embodiments, the connection may be terminated at any time. For example, this is either carried out by an action of the user within the web browser (e.g. a click on a further link or a click on the same link), or the B-participant may end the call.

In embodiments of the invention, the connection establishment may be achieved via a single mouse click onto a link in the web browser, wherein the connection establishment is carried out via the WebRTC® protocol (in connection with a SIP library).

Furthermore, in embodiments, a parallel data exchange is possible. In parallel to the existing connection (voice/video), one or several data channels may be used (based on WebRTC® or also based in SIP) in order to exchange any data or also to control background processes. For example, this data may be payment data and/or customer data and/or product data and/or information and/or file transfer data and/or screen-sharing data, etc.

In embodiments, a media discontinuity is further prevented. Due to the fact that the browser does not leave the focus of the user, the problem of the media discontinuity is solved.

Furthermore, in embodiments, an interruption of the customer journey does not occur and a closure of the data gap is realized. Due to the fact that the entire process is, or remains, IP-controlled, systems for recording the customer behavior (such as Google Analytics®) may be seamlessly integrated and various states (the attempt of a connection establishment, possible error search, duration of the connection, etc.) may be recorded. Embodiments may be linked to existing web-tracking solutions and enable a seamless analysis (call tracking).

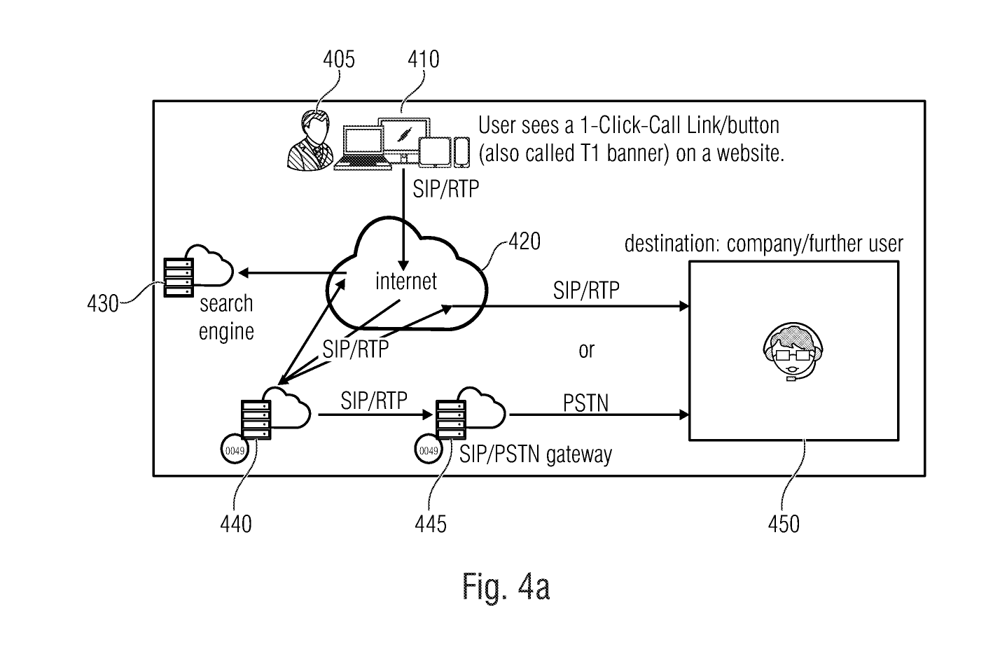

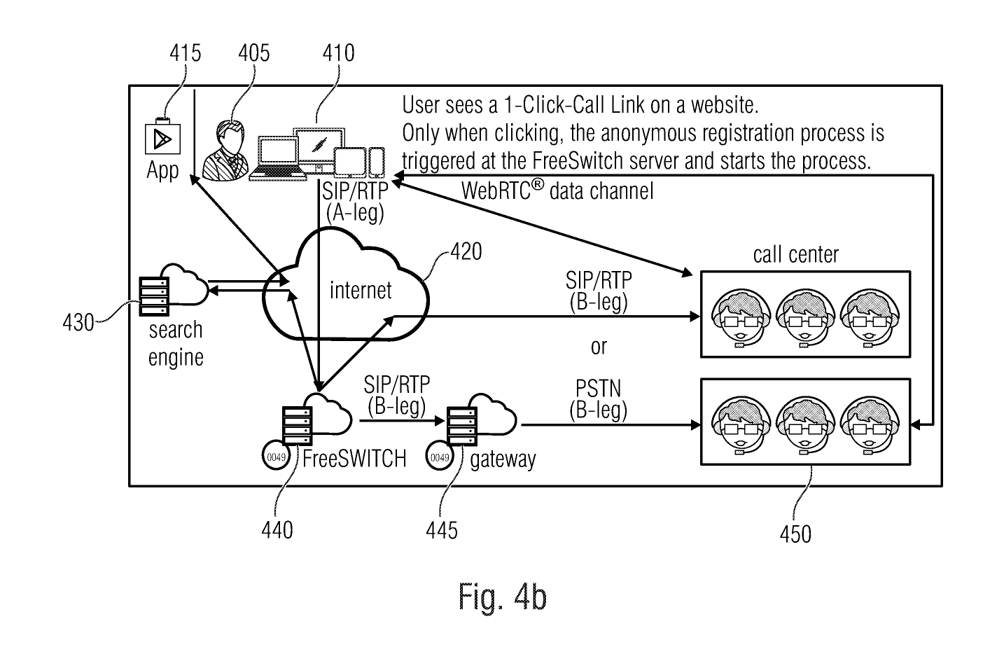

FIG. 4a and FIG. 4b show special embodiments, wherein a click on the link (or the button) triggers a series of actions. FIGS. 4a and 4b provide a technical illustration for implementing a 1-Click-Call.

A user 405 uses one of his/her terminal devices 410 such as a mobile telephone, a smartphone, a tablet or a computer and uses a program or an app 415 such as a web browser to use the internet 420. For example, he/she enters the name of a company into a search engine 430 and is supplied with a website having search results of the search engine 430. For example, a 1-Click-Call link may be built into the returned website. Clicking on it triggers the anonymous registration process at the FreeSwitch® server 440 and sets the process in motion, i.e. the establishment of the connection.

With this, a SIP/RTP (Session Initiation Protocol/Real Time Protocol) connection to a FreeSwitch® server 440 is established, the so-called A-leg.

Furthermore, a B-leg connection is established between the FreeSwitch® 440 to the B-participant which represents the destination 450 such as a company or another user 450 (e.g. a call center 450 in FIG. 4b). In this case, the B-leg connection may be purely setup as a SIP/RTP connection. Or, alternatively, the B-leg connection may be executed via a gateway 445, wherein the connection between the switch 440 and the gateway 445 may be realized as a SIP/RTP connection, and may be executed between the gateway 445 and the B-participant 450 via the telephone network (PSTN).

For example, the above communication unit 350 of FIG. 1a, FIG. 1b and FIG. 1c, and of FIG. 1g, FIG. 1h and FIG. 1i may be the destination 450 of FIG. 4a and FIG. 4b. In other words, the destination 450 of FIG. 4a and FIG. 4b is an example of a communication unit 350 of FIG. 1a, FIG. 1b and FIG. 1c, and of FIG. 1g, FIG. 1h and FIG. 1i.

For example, in a special embodiment, the connection establishment may be realized as follows: First, an initialization step may optionally be provided. For example, one or more JavaScript objects could optionally be initialized in this step.

In a further step, the connection establishment with a switching center is carried out, e.g., the FreeSwitch® server 440. Thus, the establishment of the A-leg connection is carried out.

In a further step, a data transmission to a tracking software may optionally be provided. In this step, e.g., the information that a connection establishment to the B-participant has been initialized by clicking the link may be transmitted to the tracking software.

As a further step, the query of a database in the FreeSWITCH® 440 may be provided.

FreeSWITCH® is a freely available software solution for mapping all the functions of a telephone system. For details on FreeSwitch® see:

[19]: https://en.wikipedia.org/wiki/FreeSWITCH).

Furthermore, the routing to a determined destination 450, the B-participant, is carried out (in FIG. 4b the call center 450). With this, the B-leg is established.

In a further step, the connection is bridged.

FIG. 4b shows the same structure as FIG. 4a. Additionally, in FIG. 4b, an exemplarily established WebRTC® data channel can be seen between the terminal device 410 of the user 405 and the call center 450.

Furthermore, a further interaction of the search engine 430 with the app 415 on the terminal device 410 of the user 405 can be seen in FIG. 4b.

If the communication is ended by the A-participant or by the B-participant, e.g., the termination of the connection is carried out in a final step.

In some embodiments, an integration of payment systems is realized.

Today's systems signalize fee units with the help SS7. In contrast, some embodiments of the invention enable the integration of modern payment gateways if these offer an IP-supported communication.

In some embodiments, for realizing in-call payment, the technical integration of a payment gateway is carried out.

In some embodiments, by integrating an IP-supported payment gateway, different options are realized. This may be referred to as “in-call payment”. This term is understood to be analogous to today's term of “in-app payment” (for example, see:

[20]: https://developer.apple.com/in-app-purchase/;

with respect to payment within an app, see for example:

[21]: http://t3n.de/news/payone-sdk-in-app-payment-ios-452253/):

Some embodiments are implemented such that a payment may take place within a connection (audio and/or video). Payment data is then exchanged in parallel to the actual connection.

For example, in a first special embodiment for the integration of payment systems, a connection (“call”) may be charged starting at any time in a time-based manner, e.g. 1.99 €/min. This may be compared to today's payment system “0900”. In contrast to current systems, the pricing may be changed at any time during the call. Above all, a change of pricing may be controlled by the B-participant in real time (live).

In a second special embodiment for the integration of payment systems, a call may be priced in an event-controlled manner starting at any point in time, e.g. 4.99€/connection. This may also be compared to today's payment system “0900”. In contrast to current systems, these events may also be triggered several times during one connection. For example, triggering an event is possible by the B-participant.

A third special embodiment for the integration of payment systems combines the first special embodiment for the integration of payment systems and the second special embodiments for the integration of payment systems in any way or manner.

In embodiments for the integration of payment systems, the pricing may be limited in any way. Micro-payments as well as payments of large amounts (e.g. 1,000 €) are possible. In contrast, systems according to the conventional technology comprise clear restrictions (see above).

Furthermore, embodiments for the integration of payment systems enable a free connection for the A-participant. A freely-definable pricing in the sense of the above first special embodiment and the second special embodiment as well as their combination is possible, charging the B-participant. For example, an advertiser may instruct a search engine company to place advertising. The search engine then displays a link according to an embodiment (e.g., the link may be referred to as 1-Click-Call), the advertiser pays the search engine company for the click or for the connection, the caller himself paying nothing.

The first, second and third special embodiments for the integration of payment systems may be used, e.g., to activate special features on a website (feature expansion) or to bill a service directly on the telephone (consulting). Or in the sense of Ad-Words: an advertiser pays for the call (click).

Payment gateways that may be used in embodiments are offered by various companies. For example, “AndroidPay®” is a payment system from the US company Google® for Android® devices (see also:

[22]: https://www.android.com/pay/ and

[23]: https://de.wikipedia.org/wiki/Android_Pay).

In an embodiment, the integration of “Android Pay” ® is carried out. In other embodiments, other payment systems are analogously used, e.g. “Apple Pay” ®, “PayPal” ®, “sofortuberweisung.de” ® and others (for “Apple Pay” ®, see:

[24]: https://de.wikipedia.org/wiki/Apple_Pay;

for “PayPal” ® see for example:

[25]: https://de.wikipedia.org/wiki/PayPal;

for “sofortuberweisung.de” ® see for example:

[26]: https://de.wikipedia.org/wiki/Sofort % C3% BCberweisung).

For example, embodiments for the integration of payment systems realizing in-call payment may make it possible that a payment process may be triggered at any time during an existing connection, or a payment per time unit may be charged starting from any point in time. The payment process may be variably changed at any time. This solution is much more flexible and accurate than conventional technology systems. In contrast to this, there are significant differences between conventional systems in the pricing of landline and mobile networks. This is because pricing of 0900 numbers in the landline network and for mobile communications may differ considerably.

For example, in embodiments for the integration of payment systems, it may be realized that the A-participant does not pay anything for a click onto 1-Click-Call link. The advertiser pays an amount to the company placing the advertisement for this call. The innovations are reflected in the points mentioned above. A new form of use will be implemented that includes call, tracking and payment by the advertiser.

For example, embodiments may interact with the “Google-API” ®. During the existing connection, e.g., a data exchange with servers of Google® may take place. For example, this could be triggering a payment process through the control of a “Google-API” ®. Then, Google® could send a corresponding message to the payment app of the user. Then, the app could request the user to authorize the payment. The communication process could then be continued including a billing possibility of the connection itself via a feedback from the app to Google® and from there to the FreeSwitch® server.

In the following, specific embodiments of the invention are exemplarily described.

For a better understanding, some terms will be explained first:

End user: Here a person who, e.g., uses a smartphone and a browser such as an Android® smartphone and a Chrome® browser.

Switching center: A server providing telecommunication switching services such as a FreeSWITCH® server (FreeSWITCH® is based on open source software). Other servers that provide telephone switching services are also conceivable, such as an Asterisk® server/the use of Asterisk®. Commercial servers that provide telecommunication switching services may also be used.

Web server: What is meant is a server that can deliver static and dynamic websites. For example, an Apache® web server or Microsoft® IIS server.

Database server: What is meant is a server that is the basis for storing and requesting different configurations as well as master and movement data. For example, this is a MySQL® database or an Oracle® database. Configurations are often stored on file system level (i.e. as files).

End point: What is meant is a communication device which the advertiser sets up in advance and places at the advertisement network (e.g. Google®) and which is known to the switching center in order to establish the connection.

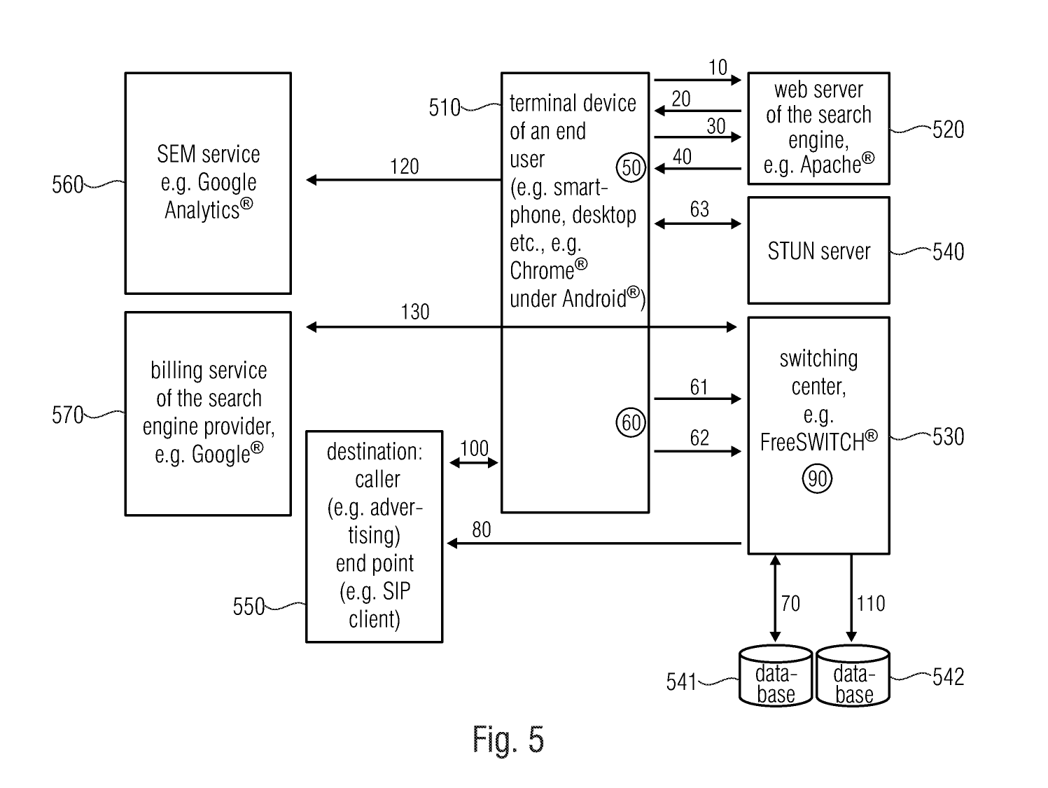

FIG. 5 shows a special embodiment that is implemented for the interaction with a search engine.

In step 10, an end user accesses with his/her terminal device 510 a website from a web server 520f of a search engine provider.

In step 20, the web server 520 of the search engine delivers the website back to the terminal device 510 of the end user, e.g. a search mask.

In step 30, the end user inputs a search term into the search mask via his/her terminal device 510 and sends a request to the web server 520 of the search engine.

In step 40, the web server of the search engine delivers the search result back as a website including a link according to the embodiment (may be referred to as 1-Click-Call link).

In embodiments, instead of, or in addition to, inputting a search term in step 30 into a search field, entering the search term may also be carried out via speech input.

Instead of, or in addition to, visually displaying the search results with the link in step 40, the search results may also be read out loud by an automatic computer speech output, wherein the selectable link is particularly indicated, e.g. via the speech output “select link [name of the link]?” or via a similar speech output.

In step 50, the end user clicks on the link by means of his/her terminal device 510. Alternatively or additionally, selection of the link according to the embodiment (e.g. a so-called 1-Click-Call link) may also be carried out via a speech input.

In embodiments, an initialization of a SIP user agent is carried out in step 60. In particularly advantageous embodiments, program code may be used, such as described in the code example below, or program code, that may be comparable to the program code described in the code example below.

In an example, an entirely optional registration to a server that provides telecommunication services, e.g. a FreeSWITCH® 530, could be carried out in step 61. It is important to know that such a registration as a “client” is entirely optional.

Even if a personal registration is not used at this point, the data is subsequently linked to a unique (unambiguous) user ID (e.g. see step 120 below).

Some embodiments are characterized by the fact that there is no registration with the server that provides telecommunication services, e.g. the FreeeSwitch® server 530. If there is no registration, an anonymous call is started.

In step 62, a connection is started, e.g. a SIP call, wherein the so-called A-leg, i.e. the connection to the server that provides telecommunication services, e.g. the FreeSwitch® server, is established first. A connection to a fixed destination 550 is to be established, e.g., a fixed destination 550 that may be designated by a SIP address (e.g. the SIP address: “sip:9999@0049.org). The connection may be started using source code, as described in the code example below.

For example, the above communication unit 350 of FIG. 1a, FIG. 1b and FIG. 1c and of FIG. 1g, FIG. 1h and FIG. 1i may be the fixed destination 550 of FIG. 5. In other words, the fixed destination 550 of FIG. 5 is an example of a communication unit 350 of FIG. 1a, FIG. 1b and FIG. 1c, and of FIG. 1g, FIG. 1h and FIG. 1i.

The session initiation protocol (SIP) is a network protocol for establishing, controlling and terminating a communication session between two or more participants (see:

[27a]: https://de.wikipedia.org/wiki/Session_Initiation_Protocol; or:

[27b]: https://en.wikipedia.org/wiki/Session_lnitiation_Protocol,

see “protocol operation” in particular).

SIP is specified, inter alia, in RFC 3261, see:

[28]: http://www.rfc-base.org/txt/rfc-3261.txt.

SIP is often used in IP telephony.

In a special embodiment, establishment, control and termination of the communication session are realized, inter alia, by employing given browser, by employing WebRTC®, which is given within the browser, and by employing the JavaScript library SIP.js (freely available under [11] http://sipjs.com/). In this embodiment, a further JavaScript file is additionally employed, e.g. the source code of the JavaScript file “1clickcall.js”, as is described in the code example below.

This, in an embodiment, a further library such as SIP.js is used in addition to an available browser and the available WebRTC®.

In other embodiments, other libraries which fulfill the same purpose, e.g. JsSIP, may alternatively be used, see:

[29]: http://jssip.net/.

Such a library may be used so that the SIP communication (audio+video) may take place with a SIP server (here FreeSWITCH®).

In other embodiments, a communication connection is realized with a “non-SIP protocol” that comprises the corresponding libraries and server APIs.

In embodiments, a global UUID (Universally Unique Identifier) may be employed in order to implement anonymous communication, see: RFC 4122:

[30]: https://tools.ietf.org/html/rfc4122; see:

[31a]: https://de.wikipedia.org/wiki/Universally_Unique_ldentifier or:

[31b]: https://en.wikipedia.org/wiki/Universally_unique_identifier.

A dynamic generation may be used. In special embodiments, an anonymous registration ID may be used in order to implement anonymous communication. Furthermore, e.g., key stones may be used.

In an optional step 63, the query of an STUN server 540 may be carried out in order to circumvent the possibly present NAT problems. (STUN=Session Transversal Utilities for NAT; NAT: Network Address Translation). STUN is a simple network protocol in order to detect the presence and the type of firewalls and NAT routers and to penetrate NAT routers. It is to allow the uncomplicated use of devices (e.g. SIP telephones) and computer programs in home networks which want to receive data from the internet, for STUN, see for example:

[32a]: https://de.wikipedia.org/wiki/Session_Traversal_Utilities for NAT or

[32b]: https://en.wikipedia.org/wiki/STUN.

In step 70, a database search is carried out via the FreeSWITCH® process. In this case, the server queries the destination 550 the A-participant (end user) is to be connected to. For this, the database 541 may be present on the server itself or on a third server.

In other embodiments, the destination 550 may also be directly obtained via API from a web server 520 of the search engine. (For example, it is conceivable that the destination is directly obtained from a Google® server). In this case, the database 541 would be “external”.

The code example below represents an implementation in case that the database 541 is stored on the FreeSWITCH® server itself; see “configurations of the extensions in the FreeSWITCH®”.

In step 80, the establishment of the B-leg is carried out according to the configuration of the destination 550 (e.g. the advertiser) of the connection. For example, a SIP client that is the destination 550 of the connection may be identified by a SIP address (e.g.: sip:mueller_fensterreinigung@0049.org) or a landline or mobile telephone number may identify the destination (e.g. “+4912345600”).

A special embodiment may be implemented such that, if the destination 550 (e.g. an advertiser) is a SIP address, a corresponding SIP connection is established via IP. If the destination 550 (or the end point that is the destination of a connection) is a telephone number (landline or mobile telephone), e.g., a gateway from IP to PSTN is used (cf. the gateway 445 in FIG. 4a and FIG. 4b). For example, corresponding gateways are provided by telephone network operators.

In a first special embodiment, several destinations are simultaneously indicated. With this, it is possible to simultaneously establish a connection to all indicated destinations. However, only one destination 550 is connected to the terminal device of the end user—namely the one which “responds” first (e.g. by confirming the connection establishment). Such a concept may also be referred to as Call Groups.

For example, a contractor having three employees who travel frequently may have equipped each of the employees with a mobile telephone, each of the mobile phones being set up according to an embodiment. All three mobile telephone numbers are configured as destinations. When an end user clicks on the 1-Click-Call link, all three mobile phones ring simultaneously. The employee who first answers the call (accepts the connection) is selected as the participant for the connection. The other two connections are dropped.

In a second special embodiment, a profile-controlled modification is carried out by means of analysis of the user behavior. Search engine operators such as Google collect huge amounts of data and generate profiles of individual users. This profile data may now be used to deliver a corresponding variation of the 1-Click-Call link.

For example, if an end user is interested in the subject of “health insurance” and, in a later process, performs searches in the subject area of “insurer”, a corresponding 1-Click-Call to an insurer may be displayed to this user. This link may even be routed to a particular employee who may immediately give topic-related advice.

In embodiments, for example, an analyzer unit either selects a first SIP address such as sip:krankenversicherung@0049.org, or a second SIP address such as sip:immobilienfinanzierung@0049.org, doing so depending on the automatic analysis of the user behavior performed by the analyzer unit. In this way, the user may be redirected to the right customer adviser.

In a third particular embodiment, the first particular embodiment and the second particular embodiment are combined with each other.

In special embodiments, the profile-controlled modification of apps, etc. is carried out.

In other embodiments, the automatic analysis of the user behavior is carried out depending on previous user inputs on previous websites. For example, cookies may be used to store information on previous user behavior. In particularly advantageous embodiments, e.g., search terms which the user has previously entered into a search engine are stored, and these are then automatically analyzed by an analysis unit, e.g., by using these old search terms in a database query. Thus, e.g., the search term “additional dental insurance” may be used in a database query, for example a database query in the form of:

SELECT “additional dental insurance” FROM sipaddresses

or a database in the form of:

SELECT sip_destination FROM sipaddresses WHERE search_history=“additional dental insurance”.

For example, as a result of the database query, sip:krankenversicherung@0049.org may be delivered as a return value of the database query.

An old search term such as “real estate” may then be used in a database query, for example a database query in the form of “

SELECT “real estate” FROM sipaddresses

or a database query in the form of:

SELECT sip_destination FROM sipaddresses WHERE search_history=“real estate”

and may for example return sip: immobilienfinanzierung@0049.org as a result of the database query.

Thus, in special embodiments, an analysis unit 327 is configured to select a destination address of the communication connection depending on a user behavior such as previous entries on websites.

In further embodiments, a modification of a website or an app is carried out based on call content. This may be carried out online and during the existing connection. For example, “in-call advertising” (advertisement during the connection) may be carried out, wherein advertising content is displayed, the content depending on the course of conversation.

For example, it is conceivable that a speech analyzer, which is for example installed on the server or the terminal device of the destination 550 of the connection, carries out speech analysis with respect to the conversation. If certain keywords are used, such as “insurance” and “teeth”, e.g., the corresponding advertisement is displayed depending on the result of the speech analysis, e.g. advertisement for an additional dental insurance. For this purpose, the language analyzer may be linked to a database. For example, if the keywords “insurance” and “teeth” appear, a database query is carried out, for example in the form of:

SELECT “insurance” AND “teeth” FROM keywords.

The result of the query may then be an identifier such as an index number indicating which advertisement is to be displayed. For example, a further database query may be carried out, for example in the form of:

SELECT index number FROM advertisement,

which returns the advertising text to be displayed. Alternatively, one database query may be sufficient to deliver the advertising text, for example a database query in the form of:

SELECT “insurance” AND “teeth” FROM advertisement.

Other embodiments comprise other combinations of database queries that serve for delivering the advertising text to be displayed.

In further embodiments, the communication participant using the hardware of the destination 550, e.g. an employee of the call center, manually selects the advertisement to be displayed from a list displayed on a computer display. The advertisement is then displayed to the user of the terminal device 510 on his/her terminal device, e.g. by transferring the advertising data from the destination 550 to the terminal device 510 via a further independent data channel. This further data channel differs from the one or several channels employed for using the audio and/or video data so that the audio and/or video communication is not disturbed.

In other embodiments, however, the same one or several channels used for transferring the data for the audio and/or video communication are also used for transferring advertising data. In such embodiments, data channels are saved. Such an embodiment is particularly suitable when the communication infrastructure is limited.

In step 90, the bridging of the participants is carried out.

While the A-leg is held (dial tone), a connection is established to the B-leg. As soon as the B-participant accepts the connection (“answering”), the connection, i.e. the two channels, is bridged. For example, on the website

[33]: http://www.voip-info.org/wiki/view/Asterisk+cmd+Dial

the process of bridging is explained as follows: The originating channel that calls the dial command is then answered and the two channels are connected together (“bridged”) allowing a conversation to take place between them. In other words, e.g., the A-leg (in FIG. 5 the connection between the terminal device 510 and the switching center 530) and the B-leg (in FIG. 5 the connection between the switching center 530 and the destination 550) are bridged.

In step 100, the transfer of audio and/or video data is carried out. Usually, RTP data (RTP=Real Time Protocol) is directly transmitted between the SIP-participants. However, there are scenarios where this may lead to problems for technical reasons, and the data streams are routed via a TURN server. (see:

[34]: https://en.wikipedia.org/wiki/Traversal_Using_Relays_around_NAT).

In step 110, the storage of the connection data, which may also be referred to as CDR (CDR=Call Detail Record), is carried out. A CDR contains the information that is involved for a billing system in the field of telecommunication. Further terms for this are communication data set, connection data set, one-on-one conversation record or telephone record. Mobile telephone companies also create CDRs for SMS, MMS and WAP connections, i.e. for all connections that may be billed to a customer (see:

[35a]: https://de.wikipedia.org/wiki/Call_Detail_Record or

[35b]: https://en.wikipedia.org/wiki/Call_detail_record).

For example, the storage is carried out by means of a database (in FIG. 5 database 542).

In step 120, a transmission of call events (connection events) to a server 560, i.e. a call event server 560, is carried out, e.g. by means of SEM-API (e.g. from “Google Analytics” ®). (SEM=Search Engine Marketing; API=Application Programming Interface) for SEM, see:

[36a]: https://de.wikipedia.org/wiki/Suchmaschinenmarketing or:

[36b]: https://en.wikipedia.org/wiki/Search_engine_marketing.

“Google Analytics” ® is an online service of the US company Google® that serves for the data traffic analysis of websites. Among other things, the service evaluates the origin of the visitors, their duration on individual sides as well as their use of search engines and also serves for the success control of advertising campaigns (see:

[37a]: https://de.wikipedia.org/wiki/Google_Analytics or

[37b]: https://en.wikipedia.org/wiki/Google_Analytics).

In connection with embodiments (also referred to as 1-Click-Call), events may be transmitted to such systems in order to evaluate these later, see:

[38]: https://support.google.com/analytics/answer/1033068?hl=de.

In embodiments according to the invention, events such as “connection started” or “connection could not be established” may be transmitted.

Here, it is important that all CDR data (CDR: Call Detail Record) is subsequently linked to a single user ID. Linking the CDR data to the unique ID may be carried out in two ways, for example: In a first case, this is carried out without a tracking software. On the end user/client side, the user is unambiguously identified with a very high probability (larger than 99%) using the so-called fingerprint method, see:

[39]: http://www.golem.de/1005/75176.html

On the server side, a global UUD is generated (a so-called GUID, see:

[40]: https://en.wikipedia.org/wiki/Globally_unique_identifier

GUID: Globally Unique Identifier;

GUIDs: Globally Unique Identifiers)

so that all 1-Click-Call datasets may be linked to this GUID. Afterwards, a reporting may be generated per user and may be provided to the business client. The GUID may also be used as a cookie, further improving a later recognition of the user (recognition of 100%).

In a second case, one or several data traffic analysis tools such as “Google Analytics” ® are used. For example, if “Google Analytics” ® is used on the website, the “Google Analytics User ID” ® is linked to 1-Click-Call data. A subsequent transfer in “Google Analytics” ® (e.g. via the “Google Analytics API” ®) allows a reporting within “Google Analytics” ®, e.g. clarifying the following information:

Which advertising keyword has generated how many calls (in business this is referred to as leads, i.e. interested parties)?

Which user behavior on the website has led to a call?

Which user has generated how much revenue and how much of this is possibly attributed to the subsequent calls?

At this point, it is again pointed out that an authentication is not required in the web browser (e.g., a login or the like is not necessary); however, the recognition and therefore the tracking may be seamlessly combined by using unique user IDs.

In step 130, a notification that the link has been clicked is sent to the billing service server 570 of the search engine provider. There, the search engine operator (e.g. Google®) may subsequently bill the advertiser (for creating the connection). Analogously to “pay per click”, this may be referred to as “pay per call”. Background is that the advertiser should pay for the click on the corresponding link, i.e. for the initiation of the communication connection by the search engine operator. For the end customer, the (initiation of) the connection remains free of charge. For example, the advertiser may have registered in advance with the search network (e.g. Google®) (e.g. with “Google AdWords” ®) (see:

[41a]: https://de.wikipedia.org/wiki/Google_AdWords or:

[41b]: https://en.wikipedia.org/wiki/AdWords)

and may have booked advertisement accordingly. For example, in case the advertiser wants to use embodiments according to the invention (1-Click-Call), he/she may have the possibility to particularly indicate this and may then have the possibility to indicate at least one end point 550 (at least one destination 550) (to configure the same at the search engine operator).

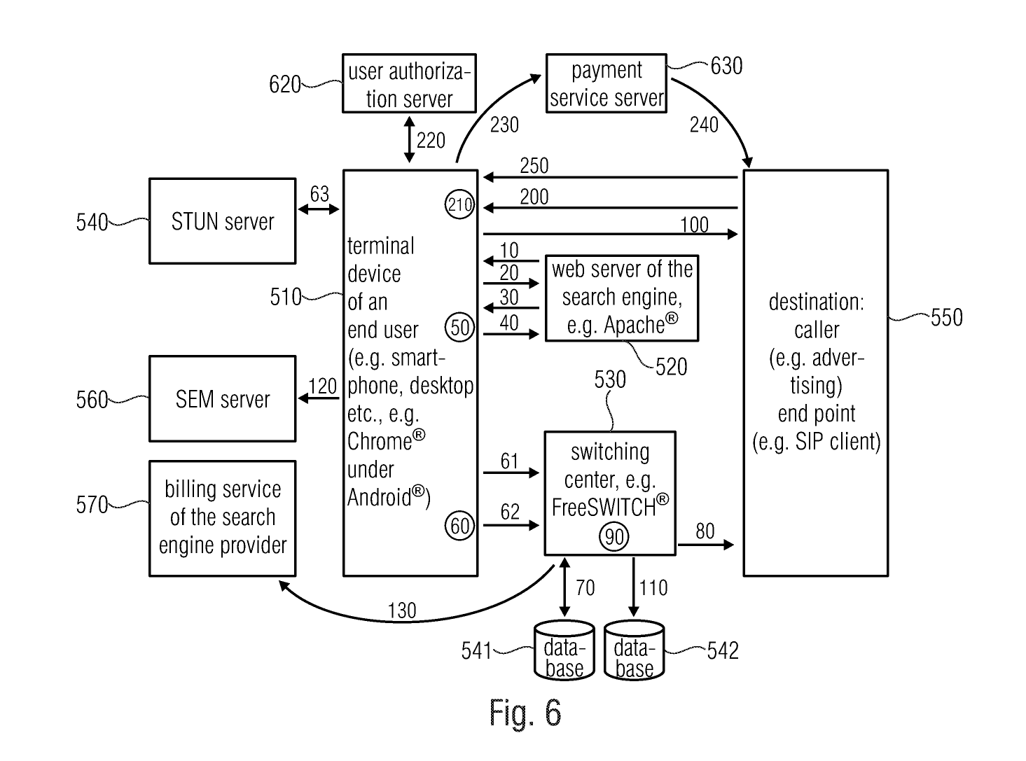

FIG. 6 shows a flow diagram for the link with in-call payment. In this case, the embodiments of FIG. 6 represent an extension of the embodiments of FIG. 5. Particularly, FIG. 6 shows in addition to the units of FIG. 5 a user authorization server 620 and a payment service server 630. The user authorization server 620 and the payment service server 630 may be provided by a search engine provider (e.g. Google®).

At any time of the connection, the terminal device (e.g. server) 550 of the B-participant may verbally indicate a payment request and may subsequently send dynamic content via SIP to the terminal device 510 of the A-participant 510. The dynamic content is initially transferred via JSON (JSON: JavaScript Object Notation) and is then displayed at the terminal device 510 of the A-participant by means of DOM (DOM: Document Object Model). Initially, this may for example be HTML code that is displayed at the terminal device 510 of the A-participant. Initially, this would be a form having the possibility to carry out the payment. As soon as the payment is carried out, the terminal device 550 of the B-participant may perform its service for the B-subscriber. This may be a consultation or other content that is dynamically delivered via SIP to the terminal device 510 of the A-subscriber (and displayed there).

In step 200, the (e.g. server 550 of the) B-participant triggers in his view a payment request. With this, a possible combination of HTML, CSS and JavaScript Code is transmitted via SIP to the terminal device 510 of the A-participant. Displaying the HTML and CSS codes leads to a dynamic change of the view in the browser or in the app (via DOM) at the terminal device 510 of the A-participant. Furthermore, there is the possibility to execute the transmitted JavaScript code in order to implement further logic at the terminal device 510 of the A-participant.

The Document Object Model (DOM) is a specification of an interface for the access to HTML or XML documents. It is defined by the World Wide Web Consortium. Via the so-called DOM manipulation, website contents may be changed dynamically with respect to appearance and functionality (see:

[42a]: https://de.wikipedia.org/wiki/Document_Object_Model or

[42b]: https://en.wikipedia.org/wiki/Document_Object_Model).

The transfer of non-audio and non-video data is also possible by means of SIP (see [12]: Aameek Singh, Arup Acharya, “Using session initiation protocol to build context-aware VoIP support for multiplayer networked games”, published in: Proceeding NetGames '04, Proceedings of 3rd ACM SIGCOMM workshop on Network and system support for games, pages 98-105, ACM New York, N.Y., USA, 2004).

In step 210, the data transmitted in step 200 is evaluated. For example, HTML and CSS code is displayed or activated and, if applicable, JavaScript code is executed. This is used to transmit the payment form to the customer. For example, the form includes fields for the user name and/or the password and/or an indication of fees and/or further information texts and information images.

For example, the payment request may be confirmed by filling out the form at the terminal device 510 of the A-participant.

In step 220, user name and password are initially used for an authorization of the user with respect to a payment provider. A user authorization server 620 may be used for this. For example, APIs such as the APIs of the “Google Identity Platform” @ may be used (see:

[43]: https://developers.google.com/identity/?csw=1).

In step 230, after the authorization, a payment service is ordered using the authorization data and the payment request according to the amount. For this, a payment service server 630 may be used.

In an alternative embodiment, the steps 210 to 230 are replaced and, instead of a predefined form, a reference to an external payment form (external link) of a payment provider is transferred via SIP and displayed at the terminal device 510 of the A-participant. In this case, the A-participant is routed to the service of the payment provider directly in a part of the current view or in an overlay-window. There, the authorization and the actual payment process are directly carried out. After completing the payment, the A-participant returns back to the original view on his/her terminal device 510.

In step 240, the payment service server 630 notifies the client 550 of the B-participant about the successful (or failed) payment as soon as the payment has been successfully carried out. Usually, all payment providers use Call-Back-APIs such as a HTTP call-back for this.

In step 250, the B-participant may now provide his/her service (e.g. consultation) or may also transmit further content via SIP to the A-participant. This content may consist of images, videos, and/or text that may again be displayed directly on the screen of the A-participant via DOM.

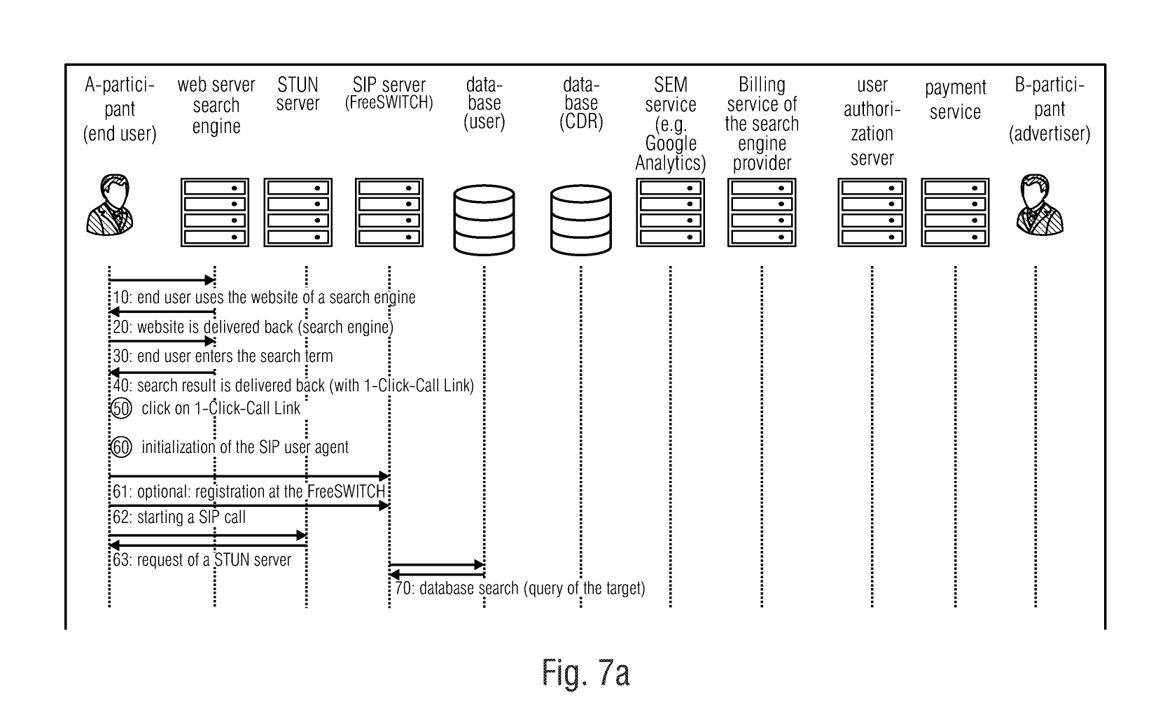

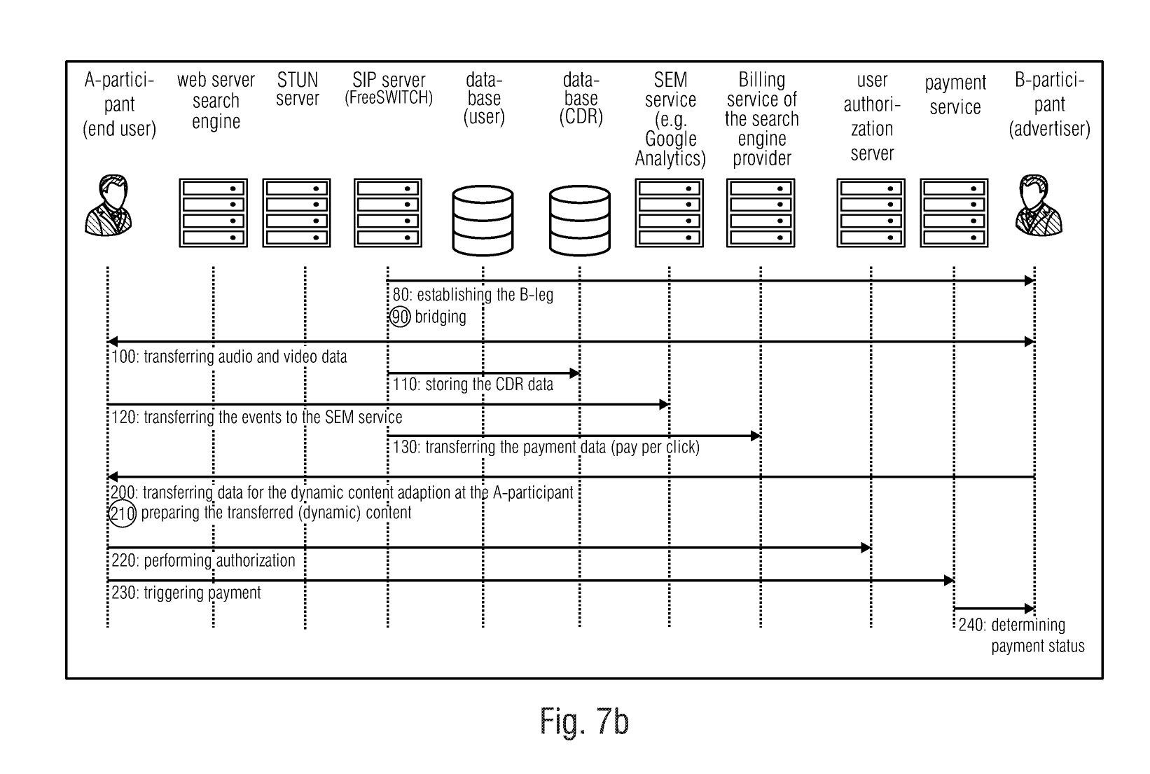

FIG. 7a and FIG. 7b show a flow diagram with in-call payment over time according to an embodiment.

The presented embodiments have several possible applications: According to an embodiment, when displaying telephone numbers, the merchant may be given the opportunity by the search engine operator to display a link or button within a selected area of the website. The control as to who may use the 1-Click-Call button may remain with the search engine operator.

A click on this button would establish a voice call or a data connection in the browser without media discontinuity and enable (telephone) communication. The view on the browser window remains at 100%, there is no app change or the like.

Such a form of communication has been learned and accepted and direct contact with the customer is usually desired.

According to embodiments, data is exchanged in real time. During the call establishment, master data may already be transmitted to the provider.

In special embodiments, this data may then be linked to CRM software (Customer Relationship Management).

Master data is automatically displayed to the provider. The end customer does not have to provide any information about his/her address data, etc. The provider is immediately shown all essential data on its screen, such as name and/or address and/or order history, etc. Fraud prevention may thus be significantly improved. Incorrect shipping due to incorrect spelling of an address by the call center employee or also due to deliberately incorrect information may be avoided.

Furthermore, the connection duration is shortened because master data is already available.

Furthermore, the user guidance by the advertiser may be optimized, since there is no media discontinuity. Previous data gaps are closed and a complete connection tracking becomes possible.

Embodiments enable the transfer of media files (texts, images, video) during the call connection.

In embodiments, the customer may be returned to the same call center employee after the connection has been interrupted, e.g., if the internet connection has been interrupted, e.g., by storing connection data.

The process from searching for a product to the payment process is no longer interrupted, since media discontinuity does no longer exist; continuous tracking of the user behavior becomes possible.

Embodiments may be combined with existing payment systems such as “Android Pay”® or the “Android Pay App”®.

In the following, advantageous embodiments of the invention are illustrated: According to an embodiment, the send/receive interface 312 may be configured to, beside to the connection-establishment message and the audio data or audio/video data or video data, additionally send user-specific data to the switching center 330; 440; 530, the user-specific data being the name or the e-mail address of the user of the apparatus.

The switching center 330; 440; 530 may be configured to transfer the user-specific data to the communication unit 350; 450; 550.

The communication unit 350; 450; 550 may be configured to display the user-specific data to a user of the communication unit 350; 450; 550.

In an embodiment, the send/receive interface 312 may be configured to request data from a social network about the user of the apparatus and, in addition to the connection-establishment message and the audio data or audio/video data or video data, to transfer the data about the user from the social network to the switching center 330; 440; 530.

The switching center 330; 440; 530 may be configured to transfer the data from the social network to the communication unit 350; 450; 550.

The communication unit 350; 450; 550 may be configured to display the data from the social network to a user of the communication unit 350; 450; 550.

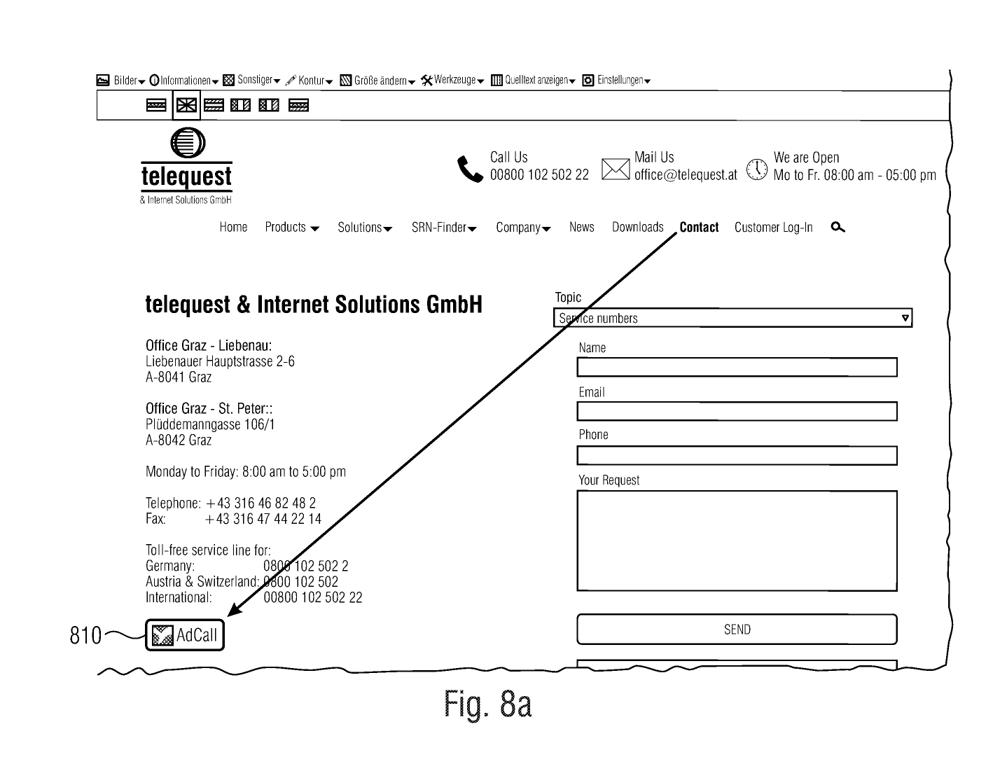

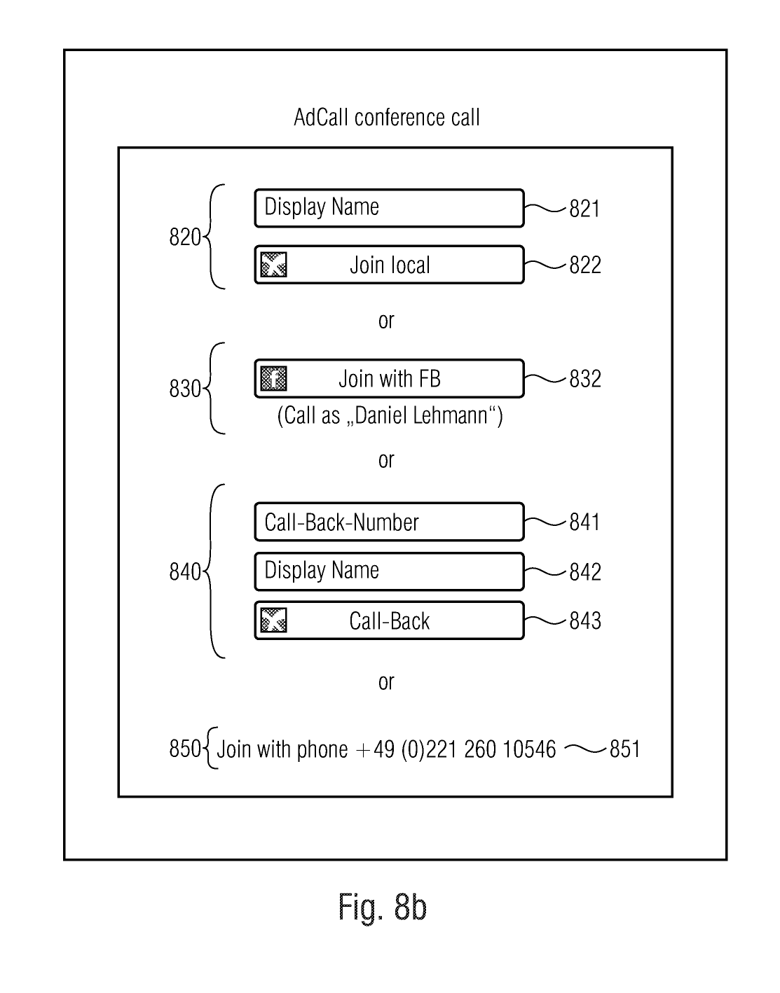

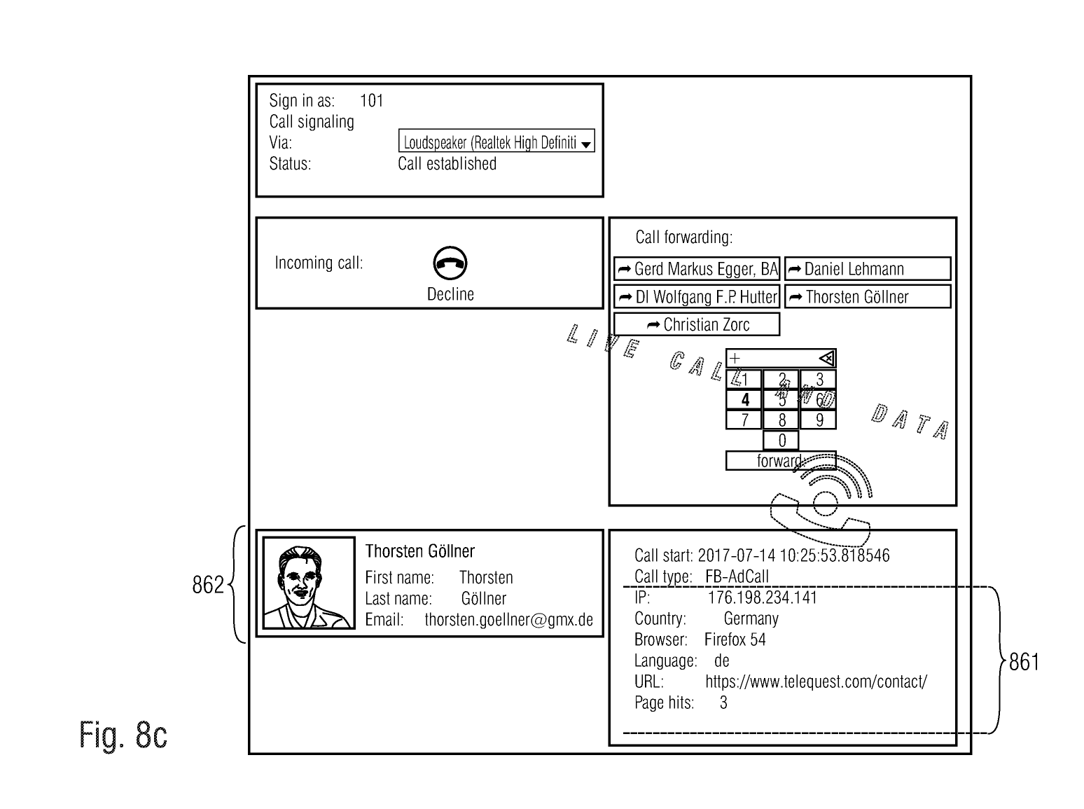

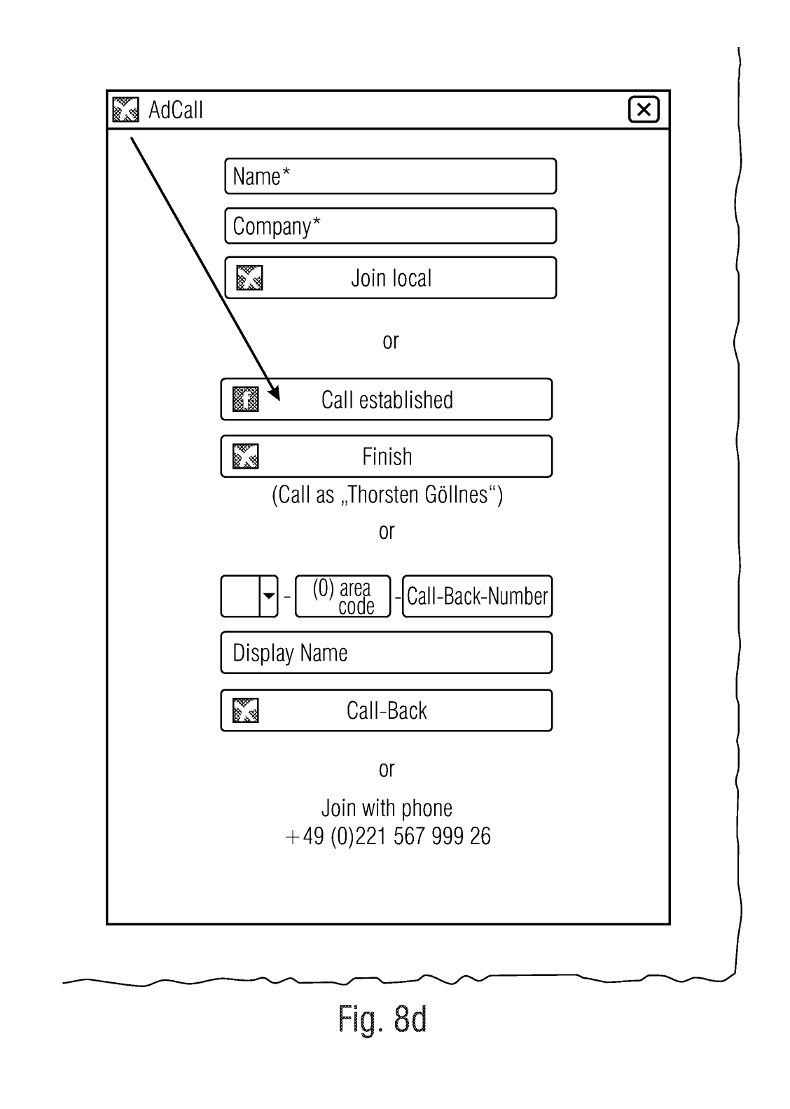

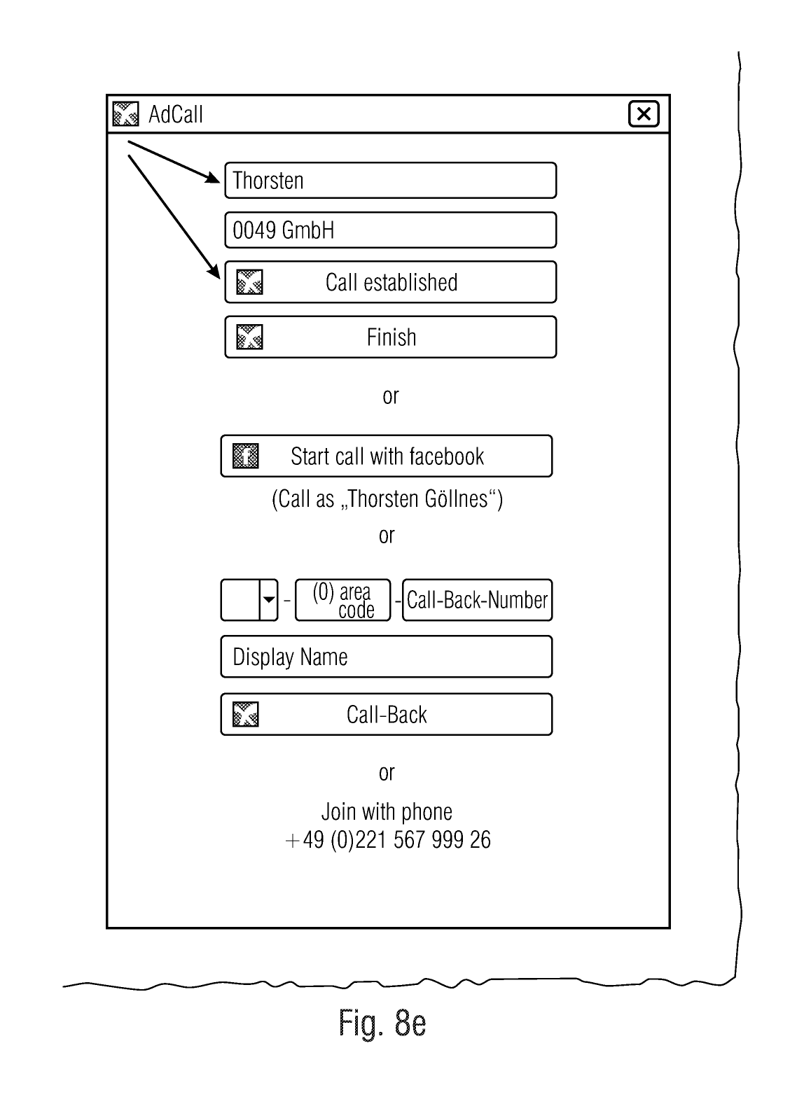

FIG. 8a shows a website displayed by an apparatus 310, 410, 510 for retrieving a website to a user. A particularity on this website is the button 810 with the designation “AdCall”.

Before displaying the website of FIG. 8a, e.g., by means of the output module 314, the apparatus 310, 410, 510 has initially loaded the code of the website, e.g. HTML code or HTML code with JavaScript®, from the web server, e.g. the web server 320.

To display the website, a module of the apparatus 310, 410, 510, e.g. the processor module 318, processes the code of the website, e.g. successively code line for code line. Then, if the module of the apparatus 310, 410, 510 reaches the code position where the button 810 is located in FIG. 8a, the module of the apparatus 310, 410, 510 finds a place holder code, e.g. JavaScript® code, that requests to reload further code from a server. This place holder code requests to reload code from the switching center 330, 440, 530. Thus, dynamic reloading of code of the website is advantageously carried out.

The code for displaying and/or for operating the button 810 is therefore loaded from a different server than the web server 320 which provides the other code for the website.

In a special embodiment, if the user now clicks on the button 810, a pop-up window opens, e.g., the pop-up window shown in FIG. 8b. Advantageously, the code for displaying the pop-up window of FIG. 8b is loaded from the switching center 330, 440, 530, i.e. from the location that also provides the code for displaying and/or operating the button 810. Particularly advantageously, this code, e.g. HTML code, is already being loaded when the code for displaying and/or for operating the button 810 is loaded from the switching center 330, 440, 530, even before the user clicks on the button 810. Alternatively, the code for displaying the pop-up window of FIG. 8b may also be loaded when the user actually clicks on the button 810.

Now, the pop-up window of FIG. 8b shows to the user different possibilities as to how he/she may connect to the communication unit 350, 450, 550. An exemplary first possibility 820 is referred to in FIG. 8b as “Join local”. An exemplary second possibility 830 is referred to in FIG. 8b as “Join with FB”. An exemplary third possibility 840 is referred to in FIG. 8b as “Call-Back”. And an exemplary fourth possibility 850 is referred to in FIG. 8b as “Join with phone”.

Embodiments of the invention also provide only a respective one of these four connection possibilities 820, 830, 840, 850, e.g. only the connection possibility 820 “Join local”, or only the connection possibility 830 “Join with FB”, or only the connection possibility 840 “Call-Back”, or only the connection possibility 850 “Join with phone”.

Other embodiments provide any possible combinations of two or three of these connection possibilities 820, 830, 840, 850.

In a special embodiment, the switching center 330 selects from a possible group of connection options 820, 830, 840, 950 only the connection options that are actually supported by the apparatus 310, 401, 510.

In embodiments, the possibilities of the terminal device may be dynamically reacted to, wherein only the connection options are displayed that may be carried out with the terminal device. For example, this is carried out via
a) a device detection or identification and
b) by designing the pop-up according to the possible capabilities of the terminal device.

For example, with some devices, the option “Join local” or “Join with FB” may be hidden due to a lack of capability.

The goal is to establish a communication connection between the apparatus 310, 410, 510 and the communication unit 350, 450, 550.

In an embodiment, the audio data and/or video data is not directly transferred between the apparatus 310, 410, 510 and the communication unit 350, 450, 550, but the audio data and/or video data is forwarded to the other communication partner via the switching center 330, 440, 530. For example, the switching center may collect statistical data about the communication connection, e.g. about the duration of the communication connection and/or the data volume involved for the communication connection for the transferred audio and/or video data.

In embodiments, the switching center 330, 440, 530 provides the communication unit 350, 450, 550 with information about the apparatus 310, 410, 510, or about the user of the apparatus 310, 410, 510. Thus, with respect to the apparatus, information about the apparatus 310, 410, 510 is collected by means of the code loaded from the switching center 330, 440, 530, e.g. JavaScript® code, wherein the information is then transferred to the switching center 330, 440, 530 (e.g. when the user clicks on the button 822, or clicks on the button 832, or clicks on the button 843, or clicks on the link 851). The collected data may then be transferred entirely, or may already have been partially transferred before, to the switching center 330, 440, 530. The switching center 330, 440, 530 then forwards the collected data entirely or partially to the communication unit 350, 450, 550, the information may then be displayed to the user of the communication unit 350, 450, 550, e.g. a call center employee, at the communication unit 350, 450, 550, which may for example be a call center. Instead of a call center employee, this may also be any other user of the communication unit, e.g. any conversation partner.

FIG. 8c shows a website that is displayed to a user of the communication unit 350, 450, 550, e.g. a call center employee. The website shown in FIG. 8c displays the data about the apparatus 310, 410, 510 or the user of the apparatus 310, 410, 510 which was transferred via the switching center 330, 440, 530. For example, this data is shown in the area 861 of the website displayed in the communication unit 350, 450, 550.

For example, the data concerning the apparatus 310, 410, 510 which is initially transferred from the apparatus to the switching center 330, 440, 530 and from there to the communication unit 350, 450, 550 may be the IP address of the apparatus 310, 410, 510 (in FIG. 8c: “176.198.234.141”), the country where the apparatus is located (in FIG. 8c: “Germany”), the browser displaying the website of FIG. 8a at the apparatus 310, 410, 510 (in FIG. 8c: “Firefox 54”), the language used at the apparatus 310, 410, 510, the web address of the website currently displayed at the apparatus 310, 410, 510 and the previous page hits of the apparatus 310, 410, 510, e.g. from the web server 320.

The transferred data may be information about an advertisement medium on which the user has previously clicked. Thus, the B-participant (the user of the communication unit 350, 450, 550) immediately knows the advertisement medium from which the A-participant (the user of the apparatus 310, 410, 510) has established a communication connection.

Again referring to FIG. 8b, the data displayed on the website of FIG. 8c in the area 861 is transferred by the apparatus 310, 410, 510 no later than when the user of the apparatus 310, 410, 510 clicks on one of the buttons 822, 832, 843 or the link 851.

In an embodiment, the communication connection may be realized by means of IP telephony.

In a further embodiment, the apparatus may be configured to provide a user 305; 405; 505 with a first possibility to establish the communication connection by means of IP telephony and to provide a further possibility to start a communication by means of landline telephony or mobile phone telephony.

With the connection possibilities 820 “Join local” and 830 “Join with FB”, a communication connection is established as described above by means of IP telephony. In an embodiment, the (audio and/or video) data packets of this IP telephony connection are forwarded between the apparatus 310, 410, 510 and the communication unit 350, 450, 550 via the switching center 330, 440, 530.

In the connection possibility 840 “Call-Back”, the user of the apparatus 310, 410, 510 asks for a callback by means of classic landline telephony or by means of mobile phone telephony while inputting his/her telephone number (landline or mobile telephone number) into the input field 841. This request for a callback, together with the callback number input in the input field 841, is transferred to the communication unit 350, 450, 550. Advantageously, the data including the request for a callback and the callback telephone number is initially transferred to the switching center 330, 440, 530 which then transfers the request for a callback together with the callback telephone number to the communication unit 350, 450, 550. A further input field 842 may be provided in the pop-up window of FIG. 8b, in which the user of the apparatus 310, 410, 510 enters his/her name. This name may then also be transferred to the communication unit 350, 450, 550, again advantageously by transfer to the switching center 330, 440, 530 which then transfers the data including the name to the communication unit 350, 450, 550.

As mentioned above, with the connection possibilities 820 “Join local” and 830 “Join with FB”, a communication connection is established by means of IP telephony. With “Join local”, an input field 821 for inputting a name may again be provided into which the user of the apparatus 310, 410, 510 may input his/her name. Advantageously, this name is again transferred to the switching center 330, 440, 530 which then forwards the name of the user of the apparatus 310, 410, 510 to a communication unit 350, 450, 550.

The connection possibility 830 “Join with FB” represents a particularity in that, upon clicking the button 832, the apparatus 310, 410, 510 requests data referring to the user of the apparatus 310, 410, 510 from a social network, e.g., by means of an API, which data is then also transferred to the switching center 330, 440, 530. The switching center 330, 440, 530 provides this data from the social network to the communication unit 350, 450, 550, which is then displayed, e.g. on the website shown in FIG. 8c, to the user of the communication unit 330, 440, 530, e.g. a call center employee. For example, on the website of FIG. 8c, this data of the social network is displayed in area 862. For example, this data of the social network may be the given name, the last name, the e-mail address and/or a photo of the user of the apparatus 310, 410, 510. For example, the social network may be Facebook®.

FIG. 8d shows the pop-up window at the user of the apparatus 310, 410, 510, after an IP telephony connection to the communication unit 350, 450, 550 (e.g. via the communication unit 330, 440, 530) has been established by means of the connection possibility 830 “Join with FB”.

It has already been described that the establishment of a communication connection between the apparatus 310, 410, 510 and the communication unit 350, 450, 550 by means of IP telephony is advantageously carried out by sending the data packets via the switching center 330, 440, 530.

For example, when establishing the connection by means of a connection request, an identifier characterizing the web server 320 or the operator of the web server 320 operating the website displayed in FIG. 8a is then sent to the switching server. For example, this identifier may be a customer ID or customer number of the operator of the web server 320 at the operator of the switching server 330, 440, 530. Based on this customer number, the switching center 330, 440, 530 may determine the communication unit with which the communication connection is to be established.

Thus, the operator of the web server 320 may have provided to a call center employee a communication unit 350 with which the call center employee may operate the connection requests coming in from the switching center 330, 440, 530. The connection requests are then forwarded by the switching center 330, 440, 530 to the one communication device 350, 450, 550, wherein the communication device may be identified by a database request based on the customer ID or customer number, for example.

Alternatively, the operator of the web server 320 may also have provided a number of communication units 350, 450, 550 for a number of call center employees, for example. Based on the customer number of the web server 320 of the operator, the switching center 330, 440, 530 may then determine, e.g., by means of a database request based on the customer ID or customer number, which group of communication units 350, 450, 550 is designated for requests from this web server. The switching center 330, 440, 530 may then send a call-request signal to all communication units of this group of communication units 350, 450, 550, which may be noticeable at the communication units as an acoustic and/or optical output. The actual audio and/or video data packets are only sent to the first communication unit 350, 450, 550 that accepts the connection request.

The connection possibility 850 “Join with phone” has special prerequisites. Here, by clicking the link 851, a classic telephone call is carried out starting at the apparatus 310, 410, 510, e.g. by means of mobile telephony. In this variation, data that is specific to the apparatus 310, 410, 510 (e.g. the data displayed in FIG. 8c in the area 861) is also to be transferred to the switching center 330, 440, 530 and is to be forwarded from there to the communication unit. As with the other variations, a globally unique identifier is assigned to the apparatus 310, 410, 510 by the switching center 330, 440, 530 and is communicated to the same. For example, this takes place when the code for the pop-up window of FIG. 8b is transferred from the switching center 330, 440, 530 to the apparatus 310, 410, 510. Additionally, the switching center 330, 440, 530 also transfers to the apparatus 310, 410, 510 a telephone number (displayed in the link 851) for classic telephony, enabling an assignment of the data transferred from the apparatus 310, 410, 510 to the classic telephone call.

In this way, the switching center 330, 440, 530 may keep available a number of different telephone numbers from which a telephone number is selected for a connection request. In embodiments, e.g., 100 extension numbers which vary in the last two digits of the telephone number are kept available. In other embodiments, e.g., 1000 extension numbers which vary in the last three digits of the telephone number are kept available. The switching center 330, 440, 530 then selects a different telephone number for the classic telephone call for different devices that retrieve the code for the pop-up window of FIG. 8b close together in time, and stores with itself which selected telephone number is assigned to which globally unique identifier. In this way, it is possible to assign the data marked by the globally unique identifier (e.g. that is displayed in area 861) to an incoming classic telephone call.

For example, the telephone number for classic telephony may designate a telephone number at the switching center 330, 440, 530, wherein the call together with the data of area 861 is forwarded from the switching center 330, 440, 530 to the communication unit 350, 450, 550.

In other embodiments, the telephone numbers for the classic telephony are a plurality of telephone numbers at the operator of the communication unit 350, 450, 550, and the switching center 330, 440, 530 transmits to the communication unit 350, 450, 550 which telephone number the data of the apparatus 310, 410, 510 is assigned to.

Thus, in an embodiment, the switching center 330, 440, 530 is configured to assign to the apparatus 310; 410; 510 a selected telephone number for landline telephony or mobile telephony from a group of telephone numbers. The switching center 330; 440; 530 may be configured to determine if data transferred from the apparatus 310; 410; 510 is assigned to a communication connection that is carried out between the apparatus 310; 410; 510 and the communication unit 350; 450; 550 by means of landline or mobile phone telephony using the selected telephone number. The switching center 330; 440; 530 may be configured to transmit the transferred data to the communication unit 350; 450; 550 if it has been determined that the transferred data is assigned to the communication connection that is carried out between the apparatus 310; 410; 510 and the communication unit 350; 450; 550 by means of the landline or mobile phone telephony using the selected telephone number.

FIG. 8e shows the pop-up window of FIG. 8b, after the communication connection has been established by means of the connection option 820 “Join local”.

Beside the data shown in area 861 of FIG. 8c, the apparatus may transmit further data that is transferred to the communication unit 350, 450, 550.

In an embodiment, the send/receive interface 312 of the apparatus 310, 410, 510 is configured to, beside the connection-establishment message and the audio data or audio/video data or video data, additionally transfer code of a website to the switching center 330; 440; 530, which is displayed by the apparatus to a user of the apparatus.

The switching center 330; 440; 530 may be configured to transfer the code of the website to the communication unit 350; 450; 550.

Furthermore, the communication unit 350; 450; 550 may be configured to display to a user of the communication unit 350; 450; 550 the website based on the code of the website.

In a special embodiment, the code of the website that is displayed to a user of the apparatus includes HTML code. Furthermore, the code of the website that is displayed to a user of the apparatus may include JavaScript® code.

In an embodiment, the apparatus 310, 410, 510 transfers to the user of the apparatus the code of a website, e.g. the HTML code of the website that is currently displayed by the apparatus 310, 410, 510. (The HTML code of the website may also be referred to as DOM: DOM=Document Object Model).

In some embodiments, by clicking on the AdCall button 810 in FIG. 8a, e.g., the DOM is initially stored only locally within the web browser and is only transferred with the start of the actual call (the actual connection establishment), e.g. by clicking on the JoinLocal button 822 in FIG. 8b. With this, the A-participant remains in control (data protection) and may initiate if his/her data is transferred, due to the fact that the data transfer only occurs upon establishment of the connection. Simultaneously, such a process facilitates the operation, since a click on the JoinLocal button 822 both starts the establishment of the connection and also the data transfer.

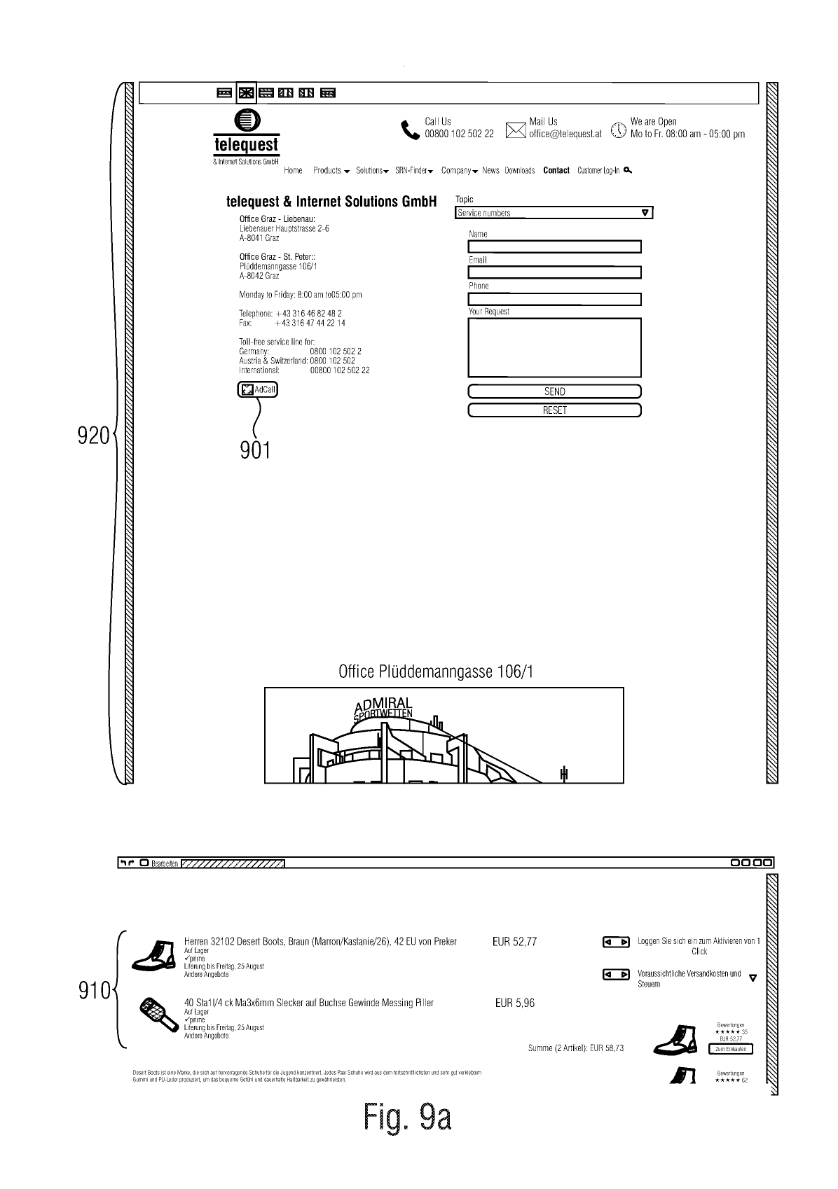

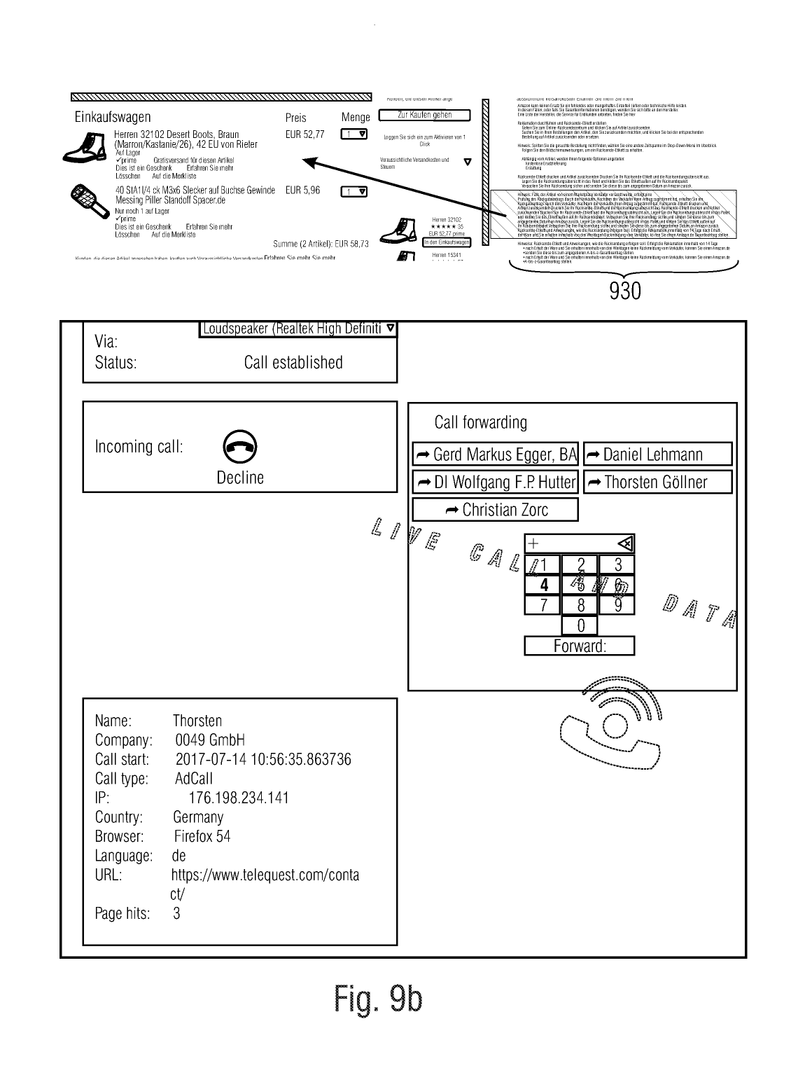

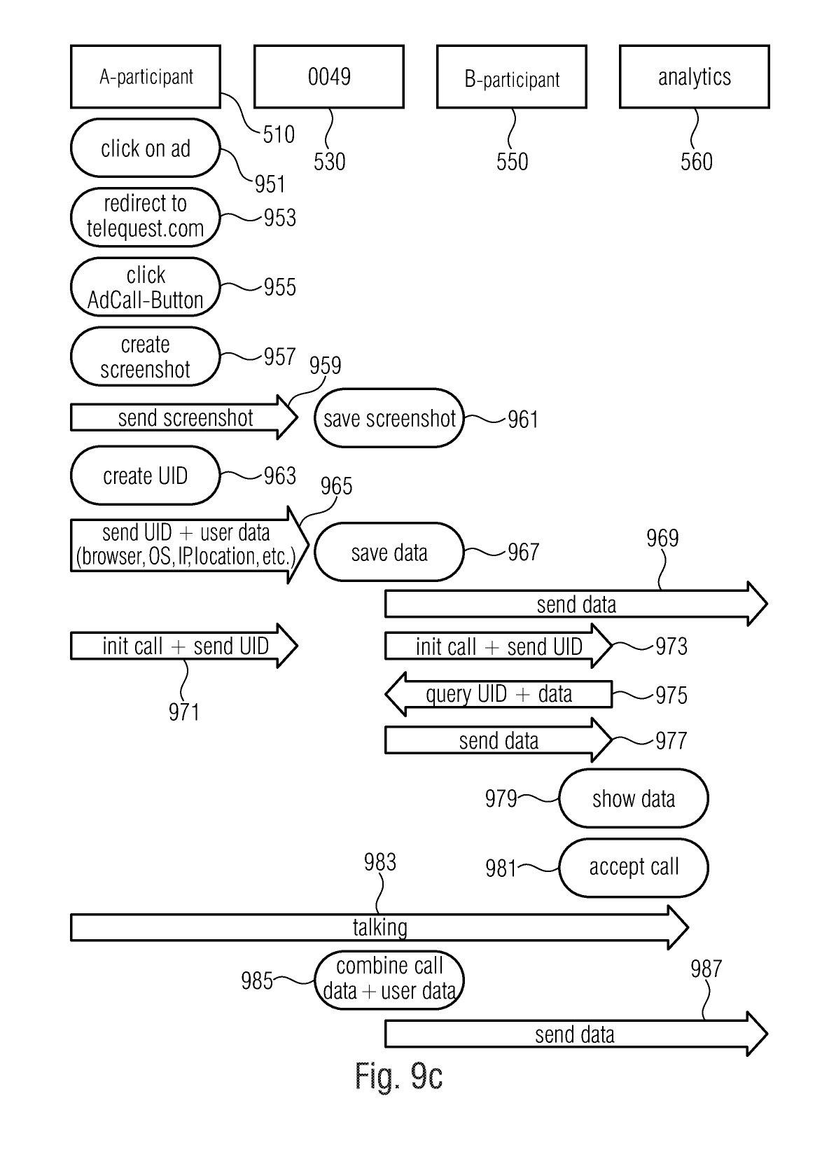

FIG. 9a shows a first website 910 that is displayed at the apparatus 310, 410, 510, and a second website 920 that is displayed at the apparatus. The first website 910 is a shopping cart which the user needs help for. The second webpage is the contact page of the web server, having a button 901 with the same functionality as the button 810 of FIG. 8a. Clicking on the button 901 opens a pop-up window corresponding to the pop-up window of FIG. 8b. No later than with a click on one of the connection options, the HTML code of the first webpage 910 is transferred to the switching center 330, 440, 530 which then transfers the HTML code of the first webpage 910 to the communication unit.

At the communication unit, the first webpage 910 is created and displayed based on the received HTML code as a website.

The screen output at the terminal device is exemplarily shown in FIG. 9b, wherein code of a partial area of the first website is exemplarily shown in area 930 of the websites.

In terms of data volume, it is more efficient to transfer the website code instead of a screenshot with individual pixels, e.g., wherein the website code includes HTML code. For example, the website code also includes JavaScript®.

The transfer of the hyperlink alone is usually not sufficient to display the website correctly in the communication unit 350, 450, 550, since, e.g., the content of a shopping cart is not encoded in the hyperlink. In particular, shopping cart data is linked to the respective session of a user and may therefore not be transferred to third parties by passing on the URL.

FIG. 9 shows a possible flow chart of an embodiment. Illustrated is an A-participant 510 which is a special example of an apparatus 510 for loading a website. The 0049 server 530 is a special example for a switching center 530; the B-participant 550 is a special example of a communication unit 550 and the analytics server is a special example for such a server.

In step 951 “Click on ad”, a button such as the button 810 is clicked.

In step 953 “Redirect to telequest.com”, a redirection to the corresponding website is carried out.

In step 955 “Click adCall button”, a button that similar to the button 822 of FIG. 8b is clicked.

In step 957 “Create screenshot”, a screenshot is symbolically created. What actually happens, however, is that the code of the corresponding website, which for example includes HTML code, is serialized, i.e. stored locally as a string (in a variable or an attribute of the string-type).

In step 959 “Send screenshot”, the HTML code of the website is transferred.

In step 961 “Save screenshot”, the HTML code received by the server 530 is stored. After storing the DOM, a browser engine on the server renders an image therefrom (in the same way as a browser which we daily work with). This image is then stored and made available for further processing (e.g. to be displayed at another communication participant). The B-participant may therefore put himself in the situation of the A-participant much faster and provide help or answer questions.

The subsequent steps are:

963: “Create UID”

965: “Send UID+user data (browser, OS, IP, location, etc)”

967: “Save data”

969: “Send data”

971: “Initiate call+send UID

973: “Initiate call+send UID”

975: “Query UID”

977: “Send data”

979: “Show data”

981: “Accept call”

983: “Talking”

985: “Combine call data+user data”

987: “Send data”

As far as the analytics server 560 is concerned, a user, e.g. of a marketing department, may aggregate and view the data. The analytics server 560 may then answer questions such as “How many users have called because of my advertisement that I have placed on a social network?” From this, conclusions may be drawn about special advertising placements. In addition, further data such as country of origin, city, browser used, etc. may be included in the analysis.

In a further embodiment, a first communication unit 350, 450, 550 has the possibility to forward an existing communication connection to another second communication unit. For this, the first communication unit sends a message to the switching center 330, 440, 530. The switching center then establishes a second communication connection between the apparatus 310, 410, 510 and the other second communication unit. If the second communication connection has been established, the switching center 330, 440, 530 terminates the first communication connection between the apparatus 310, 410, 510 and the first communication unit 350, 450, 550.

In an embodiment, the data shown in FIG. 8c in area 861 is displayed in an app on the communication unit 350.

In a further embodiment, the data shown in FIG. 8c in area 861 is to be output by means of a website.

In another embodiment, the data shown in FIG. 8c in area 861 is transferred by means of automatically generated e-mails.

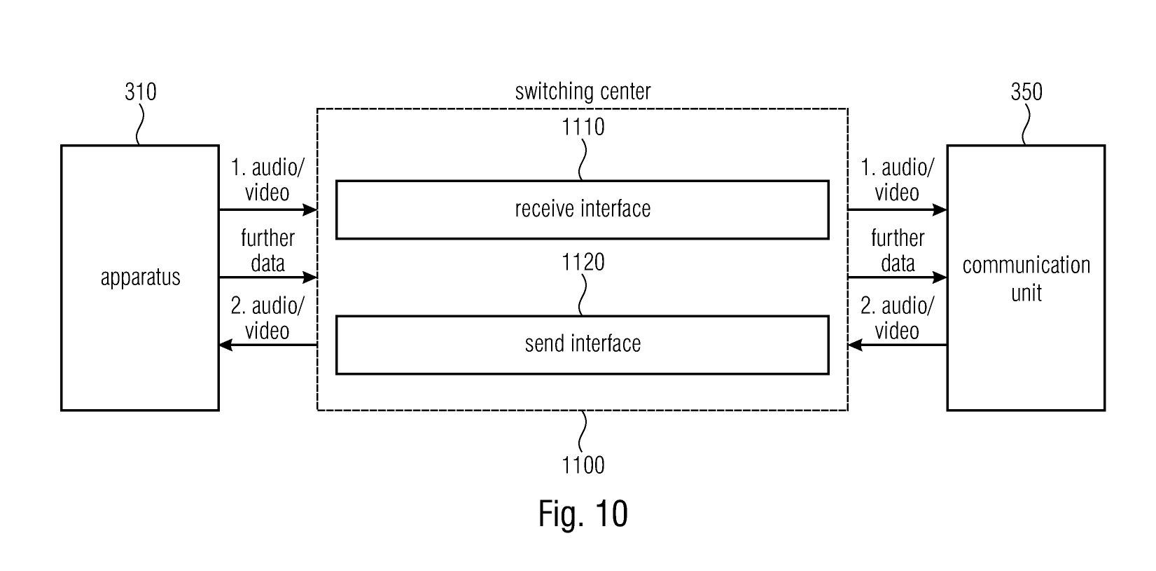

FIG. 10 shows a switching center 1100 according to an embodiment.

The switching center 1100 includes a receive interface 1110 and a send interface 1120.

The receive interface 1110 is configured to receive a connection-establishment message from an apparatus 310, wherein the receive interface 1110 is configured to, after receiving the connection-establishment message of the apparatus 310, receive first audio data or first audio/video data or first video data from the apparatus 310.

The send interface 1120 is configured to send the first audio data or first audio/video data or first video data received from the apparatus 310 to a communication unit 350.

Furthermore, the receive interface 1110 is configured to, after receiving the connection-establishment message of the apparatus 310, obtain from the apparatus 310 further data that differs from the audio data or the audio/video data or the video data, wherein the send interface 1120 is configured to send the further data to the communication unit 350.

Furthermore, the receive interface 1110 is configured to receive second audio data or second audio/video data or second video data from the communication unit 350, wherein the send interface 1120 is configured to send the second audio data or second audio/video data or second video data received from the communication unit 350 to the apparatus 310.

The switching center 1100 shown in FIG. 10 may be one of the above-described switching centers 350, 450, 550.

In an embodiment, the receive interface 1110 may be configured to obtain from the apparatus 310 code of a website as the further data. The send interface 1120 is configured to transfer the code of the website to the communication unit 350.

According to an embodiment, the code of the website may include HTML code or JavaScript® code.

In an embodiment, the receive interface 1110 may be configured to obtain user-specific data as the further data, wherein the user-specific data is the name or the e-mail address of the user of the apparatus 310. The send interface 1120 may be configured to transfer the user-specific data to the communication unit 350.

According to an embodiment, the receive interface 1110 may be configured to receive the first audio data or the first audio/video data or the first video data from the apparatus 310 by means of IP telephony. The send interface 1120 may be configured to transfer the first audio data or the first audio/video data or the first video data to the communication unit 350; 450; 550 by means of IP telephony. The receive interface 1110 may be configured to receive the second audio data or the second audio/video data or the second video data from the communication unit 350 by means of IP telephony. Furthermore, the send interface 1120 may be configured to transfer the second audio data or the second audio/video data or the second video data to the apparatus 310 by means of IP telephony.

In an embodiment, the switching center 330 may be configured to assign to the apparatus 310 a selected telephone number for landline or mobile telephony from a group of telephone numbers. The switching center 330 may be configured to determine by evaluating a globally unique identifier (e.g. added by the switching center 330) contained in the transferred data if the further data received from the apparatus 310 is assigned to a communication connection that takes place between the apparatus 310 and the communication unit 350 by means of landline or mobile telephony using the selected telephone number. The switching center 330 may be configured to transmit the further data received from the apparatus 310 to the communication unit 350 if it has been determined that the transferred data is assigned to the communication connection that takes place number between the apparatus 310 and the communication unit 350 by means of landline or mobile telephony using the selected telephone.

In an embodiment, it is also possible to forward a communication connection from a communication unit 350 to a further communication unit.

In this case, e.g., the data is transmitted from the apparatus 310, e.g. the data shown in FIG. 8c in area 861, to this further communication unit by the switching center 330.

In a special embodiment, the switching center 1100 may be configured to obtain from the communication unit 350 a signal that a first communication connection between the communication unit 350 and the apparatus 310 is to be forwarded to a further communication unit.

In this case, the switching center 1100 may be configured to indicate to the further communication unit that the first communication connection between the communication unit 350 and the apparatus 310 is to be forwarded to the further communication unit.

The switching center 1100 may be configured to transfer to the further communication unit the further data that the switching center 1100 received from the apparatus 310, which differs from the audio data or the audio/video data or the video data.

For example, this further data may be the code of the website that is displayed by the apparatus 310.

In an embodiment, a system including the apparatus 310, the web server 320, the switching center 330 and the communication unit 350 may also include the further communication unit. In another embodiment, a system including the apparatus 310, the web server 320, the switching center 330 and the communication unit 350 does not include the further communication unit.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described within the context of or as a method step also represent a description of a corresponding block or detail or feature of a corresponding device. Some or all of the method steps may be performed by means of (or while using) a hardware device, such as a microprocessor, a programmable computer or an electronic circuit. In some embodiments, some or several of the most important method steps may be performed by such a device.

Depending on specific implementation requirements, embodiments of the invention may be implemented in hardware or in software. Implementation may be effected while using a digital storage medium, for example a floppy disc, an USB memory stick or an USB storage medium, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer-readable.

Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer.

The program code may also be stored on a machine-readable carrier, for example.

Other embodiments include the computer program for performing any of the methods described herein, said computer program being stored on a machine-readable carrier. In other words, an embodiment of the inventive method thus is a computer program which has a program code for performing any of the methods described herein, when the computer program runs on a computer.

A further embodiment of the inventive methods thus is a data carrier (or a digital storage medium or a computer-readable medium) on which the computer program for performing any of the methods described herein is recorded. The data carrier, the digital storage medium, or the recorded medium are typically tangible, or non-volatile.

A further embodiment of the inventive method thus is a data stream or a sequence of signals representing the computer program for performing any of the methods described herein. The data stream or the sequence of signals may be configured, for example, to be transferred via a data communication link, for example via the internet.

A further embodiment includes a processing means, for example a computer or a programmable logic device, configured or adapted to perform any of the methods described herein.

A further embodiment includes a computer on which the computer program for performing any of the methods described herein is installed.

A further embodiment in accordance with the invention includes a device or a system configured to transmit a computer program for performing at least one of the methods described herein to a receiver. The transmission may be electronic or optical, for example.

The receiver may be a computer, a mobile device, a memory device or a similar device, for example. The device or the system may include a file server for transmitting the computer program to the receiver, for example.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU), or may be a hardware specific to the method, such as an ASIC.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

Code Example

The following code example according to embodiments is a special implementation variation of the inventive flow charts in FIG. 5, FIG. 6 and FIGS. 7a and 7b. In particular, the code example represents a special implementation of steps 40 ff. in FIG. 5, FIG. 6 and FIGS. 7a and 7b.

```
HTML code:
<!DOCTYPE html>
<html lang=“en”>
  <head>
    <meta charset=“utf-8”>
    <meta http-equiv=“X-UA-Compatible” content=“IE=edge”>
    <meta name=“viewport” content=“width=device-width, initial-scale=1”>
    <meta name=“description” content=“”>
    <link rel=“icon” href=“favicon.ico”>
    <title>1-Click-Call Demo</title>
    <script src=“https://ajax.googleapis.com/ajax/libs/jquery/1.12.0/jquery.min.js”></script>
    <script src=“/js/sip-0.7.3.min.js”></script>
  </head>
  <body>
    <p>By clicking on the following button, a 1-Click-Call (voice) to a previously configured
SIP end point is established.</p>
    <p><a id=“call_tg_handy_audio_only” href=“#”>1-Click-Call</a>
      <div id=“call_tg_handy_audio_only_status”>...</div>
      <script type=“text/javascript” src=“/js/1clickcall.js”></script></p>
  </body>
</html>
Regarding SIP.js, see [11]: http://sipjs.com/ .
1clickcall.js :
var session, userAgent;
var config = {
  register: false,
  uri: ‘sip:9999@call.0049.org’,
  wsServers: ‘wss://call.0049.org:7443’,
  authorizationUser: ‘9999’,
  password: ‘FKiuEmcn639Flp9’,
  // stunServers: [‘stun:call.0049.org:3478’, ‘stun:stun.l.google.com:19302’],
  stunServers: [‘stun:call.0049.org:3478’],
  traceSip: false,
};
var options_audio_video = {
  media: {
    constraints: {
      audio: true,
      video: true
    },
    render: {
      remote: document.getElementById(‘remoteVideo’),
      local: document.getElementById(‘localVideo’)
    }
  }
};
var options_audio_only = {
  media: {
    constraints: {
      audio: true,
      video: false
    },
    render: {
      remote: document.getElementById(‘remoteAudio’),
      local: false
    }
  }
};
function sipCall(id, callTarget, options) {
  if (SIP.WebRTC.isSupported( )) {
  if (userAgent) {
  } else {
    userAgent = new SIP.UA(config);
  }
  session = userAgent.invite(callTarget, options);
  session.on(‘bye’, function ( ) {
    session = null;
    $(“#”+id).removeClass(‘disabled’);
    $(“#”+id+“_hangup”).addClass(‘disabled’);
    if (id ==“call_tg_handy_audio_video”) {
      $(“#localVideo”).hide( );
      $(“#remoteVideo”).hide( );
    }
    document.getElementById(id+“_status”).innerHTML = ‘Idle. Call was terminated.’;
  });
  session.on(‘connecting’, function ( ) {
    if (id == “call_tg_handy_audio_video”) $(“#localVideo”).show( );
    document.getElementById(id+“_status”).innerHTML = Call is being established...’;
  });
  session.on(‘accepted’, function (d) {
    $(“#”+id+“_hangup”).removeClass(‘disabled’);
    if (id == “call_tg_handy_audio_video”) $(“#remoteVideo”).show( );
    document.getElementById(id+“_status”).innerHTML = ‘You are connected.’;
  });
  session.on(‘failed’, function (r, c) {
    session = null;
    $(“#”+id).removeClass(‘disabled’);
    $(“#”+id+“_hangup”).addClass(‘disabled’);
      if (id == “call_tg_handy_audio_video”) {
      $(“#localVideo”).hide( );
      $(“#remoteVideo”).hide( );
    }
    document.getElementById(id+“_status”).innerHTML = ‘Call currently not possible.’;
  });
} else {
    document.getElementById(id+“_status”).innerHTML = ‘WebRTC is not supported by
    your browser.’;
  }
}
// CLICK on Call button
$(“#call_tg_handy_audio_only”).click(function( ) {
  id = “call_tg_handy_audio_only”;
  callTarget = ‘sip:11@call.0049.org’;
  sipCall(id, callTarget, options_audio_only);
  return false;
});
// CLICK on Hang Up button
$(“#call_tg_handy_audio_only_hangup”).click(function( ) {
  if (session) session.bye( );
  return false;
});
```

Special embodiment for configuring the extensions in FreeSWITCH®. Here, in particular, the configuration of file/etc/freeswitch/directory/default/9999.xml:

```
<include>
  <user id=“9999”>
    <params>
      <param name=“password” value=“FKiuEmcn639Flp9”/>
      <param name=“vm-password” value=“DjreoiuNXlr8”/>
    </params>
    <variables>
      <variable name=“accountcode” value=“9999”/>
      <variable name=“user_context” value=“private”/>
      <variable name=“effective_caller_id_name” value=“Thorsten Gollner (1ClickCall)”/>
      <variable name=“effective_caller_id_number” value=“9999”/>
      <variable name=“outbound_caller_id_name” value=“$${outbound_caller_name}”/>
      <variable name=“outbound_caller_id_number” value=“$${outbound_caller_id}”/>
      <variable name=“callgroup” value=“techsupport”/>
    </variables>
  </user>
</include>
<include>
  <user id=“11”>
    <params>
      <param name=“password” value=“$${default_password}”/>
      <param name=“vm-password” value=“11”/>
    </params>
    <variables>
      <variable name=“accountcode” value=“11”/>
      <variable name=“user_context” value=“private”/>
      <variable name=“effective_caller_id_name” value=“Thorsten Gollner (Android)”/>
      <variable name=“effective_caller_id_number” value=“11”/>
      <variable name=“outbound_caller_id_name” value=“$${outbound_caller_name}”/>
      <variable name=“outbound_caller_id_number” value=“$${outbound_caller_id}”/>
      <variable name=“callgroup” value=“techsupport”/>
    </variables>
  </user>
</include>
```

### Glossary

In the following, an explanation of some terms is presented:

API: A programming interface, more precisely an interface for application programming, often only briefly called API (application programming interface), is a part of a program provided by a software system to other programs for connection to the system. In contrast to a binary interface (ABI), a programming interface only defines the program connection at source code level [1]. The provision of such an interface usually includes the detailed documentation of the interface features with their parameters on paper or as an electronic document. See:

[44a]: https://de.wikipedia.org/wiki/Programmierschnittstelle or:

[44b] https://en.wikipedia.org/wiki/Application_program ming_interface

App: Abbreviation for Application. Typically, this means a part of software which runs in a specific context (e.g. on a smartphone).

Asterisk®: Free software telephone system. See:

[45a]: https://de.wikipedia.org/wiki/Asterisk_(Telefonanlage) or:

[45b]: https://en.wikipedia.org/wiki/Asterisk_(PBX)

A-leg: Describes the distance from the A-participant to the telephone system.

A-participant: In a dial-up connection, an A-participant (also referred to as call originator or calling party) is the name given to the participant who initiated the connection. See: [18]: https://de.wikipedia.org/wiki/Teilnehmer_(Kommunikationssystem)

Bridge: In telephony, this refers to the interconnection of two or more channels. This is done so that different users can hear each other/communicate with each other.

Call center: This is primarily a telephone-based and computer-based consulting center. It is also often used for telephone sales. Call centers can be rented. Employees are trained on specific topics. Calls are then typically forwarded to the call center via a service number (0800/0900). See:

[46a]: https://de.wikipedia.org/wiki/Callcenter or:

[46b]: https://en.wikipedia.org/wiki/Call_centre

Cloud: Cloud computing describes the approach of providing IT infrastructures (e.g. computing capacity, data storage, network capacities or even finished software) via a network without having to install these on the local computer. See:

[47a]: https://de.wikipedia.org/wiki/Cloud_Computing or:

[47b]: https://en.wikipedia.org/wiki/Cloud_computing

CSS: Cascading Style Sheets, CSS, is a stylesheet language for electronic documents and, together with HTML and DOM, one of the core languages of the World Wide Web. See:

[48a]: https://de.wikipedia.org/wiki/Cascading_Style_Sheets or:

[48b]: https://en.wikipedia.org/wiki/Cascading_Style_Sheets

CDR: Abbreviation for Call Detail Record. In telephony, this is a data record which includes all features of a connection, e.g., date and time of the call, duration of the call, number of the A-participant, etc.

Content: Contents such as video, audio, texts, etc.

DOM: Document Object Model (DOM) is a specification of an interface for accessing HTML or XML documents. It is defined by the World Wide Web Consortium. See:

[42a]: https://de.wikipedia.org/wiki/Document_Object_Model or:

[42b]: https://en.wikipedia.org/wiki/Document_Object_Model

Domain: Is a coherent subarea of the hierarchical Domain Name System (DNS). In the domain allocation procedure, it is a unique and unambiguous name on the internet that can be freely selected under certain rules under a top-level domain. See:

[49a]: https://de.wikipedia.org/wiki/Domain_(Internet) or:

[49b]: https://en.wikipedia.org/wiki/Domain_name

DTMF: Dual-Tone Multi-Frequency dialing (also known as frequency dialing[1]) is the dialing technique commonly used in analogue telephone technology and, since the 1990s, has been the most widely used method for transmitting telephone numbers to an exchange or a telephone system in analogue participant lines. See:

[50a]: https://de.wikipedia.org/wiki/Mehrfrequenzwahlverfahren or:

[50b]: https://en.wikipedia.org/wiki/Dual-tone_multi-frequency_signaling

End point: A sender or receiver in communication. See:

[51a]: https://de.wikipedia.org/wiki/Kommunikation or:

[51b]: https://en.wikipedia.org/wiki/Telecommunication

Exchange: An exchange is a node within a communication network which allows the selective establishment of communication links. See:

[62a]: https://de.wikipedia.org/wiki/Vermittlungsstelle or:

[62b]: https://en.wikipedia.org/wiki/Telephone_exchange

FreeSWITCH®: Free software telephone system. See:

[19]: https://en.wikipedia.org/wiki/FreeSWITCH

HTML: The Hypertext Markup Language is a text-based markup language for structuring digital documents such as texts with hyperlinks, images and other content. HTML documents are the basis of the World Wide Web and are displayed by web browsers. See:

[52a]: https://de.wikipedia.org/wiki/Hypertext_Markup_Language or:

[52b]: https://en.wikipedia.org/wiki/HTML

In-app payment: Describes the possibility of using a payment method within an app.

In-call payment: Implemented in embodiments: Describes the possibility of implementing a payment process parallel to the existing communication connection during a connection which is established by a 1-Click-Call, for example.

In-app advertisement: Describes the possibility of placing (targeted) advertising within an app.

In-call advertisement: Implemented in embodiments: Describes the possibility of displaying advertising within the action area of the A-participant (e.g. browser window) during a 1-Click-Call in a targeted (or profile-controlled) manner.

IP (Internet Protocol): Network protocol and the basis of the internet. See:

[53a]: https://de.wikipedia.org/wiki/Internet_Protocol or:

[53b]: https://en.wikipedia.org/wiki/Internet_Protocol

ISDN: Integrated Services Digital Network is an international standard for a digital telecommunications network. See:

[56a]: https://de.wikipedia.org/wiki/Integrated_Services_Digital_Network or:

[56b]: https://en.wikipedia.org/wiki/Integrated_Services_Digital_Network

JavaScript: Primary scripting language for web browsers. See: [54]:

[54a]: https://de.wikipedia.org/wiki/JavaScript or:

[54b]: https://en.wikipedia.org/wiki/JavaScript

JSON (JavaScript Object Notation): Compact data format for exchanging data between applications. See:

[55a]: https://de.wikipedia.org/wiki/JavaScript_Object_Notation or:

[55b]: https://en.wikipedia.org/wiki/JSON

NGN: In telecommunications, Next Generation Network, or Next Generation Access Network (NGA network), refers to the network technology that replaces traditional circuitswitched telecommunications networks such as telephone networks, cable television networks, mobile telephone networks, etc. with a uniform packet-switched network infrastructure and architecture and is compatible with older telecommunications networks. See:

[3a]: https://de.wikipedia.org/wiki/Next_Generation_Network or:

[3b]: https://en.wikipedia.org/wiki/Next-generation_network

Peer-to-peer: “Peer-to-peer (P2P) connection” and computer-to-computer connection are synonyms for communication among equals, here referring to a computer network. See:

[59a]: https://de.wikipedia.org/wiki/Peer-to-Peer or:

[59b]: https://en.wikipedia.org/wiki/Peer-to-peer

PSTN (Public Switched Telephone Network): A telephone network, also known as PSTN (Public Switched Telephone Network), is a communication system designed to handle telephone calls (telephony). See:

[1a]: https://de.wikipedia.org/wiki/Telefonnetz or:

[1b]: https://en.wikipedia.org/wiki/Public_switched_telephone_network

SEM (Search Engine Marketing): A branch of online marketing. See:

[36a]: https://de.wikipedia.org/wiki/Suchmaschinenmarketing or:

[36b]: https://en.wikipedia.org/wiki/Search_engine_marketing

SEO (search engine optimization): Refers to measures which ensure that web pages appear at higher positions in unpaid search results (natural listings) in the organic search engine ranking. See:

[60a]: https://de.wikipedia.org/wiki/Suchmaschinenoptimierung or:

[60b]: https://en.wikipedia.org/wiki/Search_engine_optimization

SIP (Session Initiation Protocol): A network protocol for establishing, controlling and terminating a communication session between two or more users. The protocol is specified, among other things, in RFC 3261. SIP is a frequently used protocol in IP telephony. See:

[27a]: https://de.wikipedia.org/wiki/Session_Initiation_Protocol or:

[27b]: https://en.wikipedia.org/wiki/Session_Initiation_Protocol

SIP.js: Freely available JavaScript library for the use of WebRTC® and SIP. See:

[11]: http://sipjs.com/

Soft device: Refers to a software program which provides the (full) functionality of a SIP telephone and runs on a terminal device such as a smartphone or a PC.

Stream: In the description above, a stream often refers to an audio or video data stream.

SS7 (Signaling System #7): A collection of protocols and methods for signaling in telecommunications networks. See:

[4a]: https://de.wikipedia.org/wiki/Signalling_System_7 or:

[4b]: https://en.wikipedia.org/wiki/Signalling_System_No._7

STUN (Session Traversal Utilities for NAT): A simple network protocol to detect the presence and type of firewalls and NAT routers and to traverse the same. See:

[32a]: https://de.wikipedia.org/wiki/Session_Traversal_Utilities for NAT or:

[32b]: https://en.wikipedia.org/wiki/STUN

Telephone System: A telephone system, private branch exchange (PBX) or private telecommunication exchange is a switching device that connects several terminal devices such as telephone, fax, answering machine to each other as well as to one or more lines of the public telephone network. See:

[61a]: https://de.wikipedia.org/wiki/Telefonanlage or:

[61b]: https://en.wikipedia.org/wiki/Business_telephone_system

Value-added telephone number/service telephone number: Special telephone numbers with their own prefix. The prefix determines the intended use and, for some variations, the end customer rate. See the following two examples for the prefixes 0800 and 0900:

Prefix 0800: Available free of charge from landlines and all mobile phone networks. Companies or businesses pay for all connection costs. Usually used by companies as a service hotline for end customers. Calls are typically routed (directed) to a call center. Example: 0800 123456

Prefix 0900: On the landline, calls may be freely priced from 0 €/minute up to 3 €/minute. So-called block pricing is also possible—e.g. 1 € per call. In mobile phone telephony, calls are ambiguously priced in so-called clusters. A cluster describes a possible price range in which the mobile phone provider ultimately determines the actual end customer rate. The following generally applies: the number after 0900 determines the purpose (0900-1=>information service, 0900-3=>entertainment, 0900-5=>other services). Example: 0900 5 123456. See:

[57]: https://servicenummern.telekom.de/weitere-informationen/anrufertarife/or, for example:

[58]: https://woopla.de/service-rufnummern/0900-premium-rate/

VoIP: IP telephony (Internet Protocol telephony), also known as internet telephony or Voice-over-IP (VoIP), is telephony via computer networks that are set up according to internet standards. See:

[2a]: https://de.wikipedia.org/wiki/IP-Telefonie or:

[2b]: https://en.wikipedia.org/wiki/Telephony

WebRTC®: WebRTC® (Web Real-Time Communication) is a collection of communication protocols and programming interfaces (APIs) for implementation in web browsers that enable real-time communication via computer-to-computer connections. See:

[9a]: https://de.wikipedia.org/wiki/WebRTC or:

[9b]: https://en.wikipedia.org/wiki/WebRTC

XML: The Extensible Markup Language, XML, is a markup language for displaying hierarchically structured data in the form of text files. XML is used for the platform-independent and implementation-independent exchange of data between computer systems, especially via the internet. See:

[63a]: https://de.wikipedia.org/wiki/Extensible_Markup_Language or:

[63b]: https://en.wikipedia.org/wiki/XML

### REFERENCES

[1a]: https://de.wikipedia.org/wiki/Telefonnetz
[1b]: https://en.wikipedia.org/wiki/Public_switched_telephone_network
[2a]: https://de.wikipedia.org/wiki/IP-Telefonie
[2b]: https://en.wikipedia.org/wiki/Telephony
[3a]: https://de.wikipedia.org/wiki/Next_Generation_Network
[3b]: https://en.wikipedia.org/wiki/Next-generation_network
[4a]: https://de.wikipedia.org/wiki/Signalling_System_7
[4b]: https://en.wikipedia.org/wiki/Signalling_System_No._7
[5]: EP 398 711 B1
[6]: http://blog.linkwerk.com/2011/04/telefon-links-fur-smartphones-desktopfreundlich/
[7a]: http://www.google.com/intl/de_de/business/
[7b]: http://www.google.com/intl/en_en/business/
[8]: https://hangouts.google.com/?hl=en
[9a]: https://de.wikipedia.org/wiki/WebRTC
[9b]: https://en.wikipedia.org/wiki/WebRTC
[10a]: http://www.pro-linux.de/artikel/2/1791/firefox-hello-der-videochat-im-test.html
[10b]: https://support.mozilla.org/en-US/products/firefox/chat-and-share/firefox-hello-webrtc
[11]: http://sipjs.com/
[12]: Aameek Singh, Arup Acharya, “Using session initiation protocol to build context-aware VoIP support for multiplayer networked games”, published in: Proceeding NetGames '04, Proceedings of 3rd ACM SIGCOMM workshop on Network and system support for games, p. 98-105, ACM New York, N.Y., USA, 2004
[13]: https://freeswitch.org/confluence/display/FREESWITCH/mod_verto
[14] http://www.elektronik-kompendium.de/sites/kom/0312241.htm
[15]: https://www.android.com/pay/
[16a]: https://de.wikipedia.org/wiki/Android_Pay
[16b]: https://en.wikipedia.org/wiki/Android_Pay
[17a]: https://de.wikipedia.org/wiki/Amazon_Echo
[17b]: https://en.wikipedia.org/wiki/Amazon_Echo
[18]: https://de.wikipedia.org/wiki/Teilnehmer_(Kommunikationssystem)
[19]: https://en.wikipedia.org/wiki/FreeSWITCH
[20]: https://developer.apple.com/in-app-purchase/
[21]: http://t3n.de/news/payone-sdk-in-app-payment-ios-452253/
[22]: https://www.android.com/pay/
[23]: https://de.wikipedia.org/wiki/Android_Pay
[24]: https://de.wikipedia.org/wiki/Apple_Pay
[25]: https://de.wikipedia.org/wiki/PayPal
[26]: https://de.wikipedia.org/wiki/Sofort%C3%BCberweisung
[27a]: https://de.wikipedia.org/wiki/Session_nitiation_Protocol
[27b]: https://en.wikipedia.org/wiki/Session_Initiation_Protocol
[28]: http://www.rfc-base.org/txt/rfc-3261.txt
[29]: http://jssip.net/
[30]: https://tools.ietf.org/html/rfc4l 122
[31a]: https://de.wikipedia.org/wiki/Universally_Unique_ldentifier
[31b]: https://en.wikipedia.org/wiki/Universally_unique_identifier
[32a]: https://de.wikipedia.org/wiki/Session_Traversal_Utilities for_NAT
[32b]: https://en.wikipedia.org/wiki/STUN
[33]: http://www.voip-info.org/wiki/view/Asterisk+cmd+Dial
[34]: https://en.wikipedia.org/wiki/Traversal_Using_Relays_around_NAT
[35a]: https://de.wikipedia.org/wiki/Call_Detail_Record
[35b]: https://en.wikipedia.org/wiki/Call_detail_record
[36a]: https://de.wikipedia.org/wiki/Suchmaschinenmarketing
[36b]: https://en.wikipedia.org/wiki/Search_engine_marketing
[37a]: https://de.wikipedia.org/wiki/Google_Analytics
[37b]: https://en.wikipedia.org/wiki/Google_Analytics
[38]: https://support.google.com/analytics/answer/1033068?hl=de
[39]: http://www.golem.de/1005/75176.html
[40]: https://en.wikipedia.org/wiki/Globally_unique_identifier
[41a]: https://de.wikipedia.org/wiki/Google_AdWords
[41b]: https://en.wikipedia.org/wiki/AdWords
[42a]: https://de.wikipedia.org/wiki/Document_Object_Model
[42b]: https://en.wikipedia.org/wiki/Document_Object_Model
[43]: https://developers.google.com/identity/?csw=1
[44a]: https://de.wikipedia.org/wiki/Programmierschnittstelle
[44b] https://en.wikipedia.org/wiki/Application_programming_interface
[45a]: https://de.wikipedia.org/wiki/Asterisk_(Telefonanlage)
[45b]: https://en.wikipedia.org/wiki/Asterisk_(PBX)
[46a]: https://de.wikipedia.org/wiki/Callcenter
[46b]: https://en.wikipedia.org/wiki/Call_centre
[47a]: https://de.wikipedia.org/wiki/Cloud_Computing
[47b]: https://en.wikipedia.org/wiki/Cloud_computing
[48a]: https://de.wikipedia.org/wiki/Cascading_Style_Sheets
[48b]: https://en.wikipedia.org/wiki/Cascading_Style_Sheets
[49a]: https://de.wikipedia.org/wiki/Domain_(Internet)
[49b]: https://en.wikipedia.org/wiki/Domain_name
[50a]: https://de.wikipedia.org/wiki/Mehrfrequenzwahlverfahren
[50b]: https://en.wikipedia.org/wiki/Dual-tone_m ulti-frequency_signaling
[51a]: https://de.wikipedia.org/wiki/Kommunikation
[51b]: https://en.wikipedia.org/wiki/Telecommunication
[52a]: https://de.wikipedia.org/wiki/Hypertext_Markup_Language
[52b]: https://en.wikipedia.org/wiki/HTML
[53a]: https://de.wikipedia.org/wiki/Internet_Protocol
[53b]: https://en.wikipedia.org/wiki/I nternet_Protocol
[54a]: https://de.wikipedia.org/wiki/JavaScript
[54b]: https://en.wikipedia.org/wiki/JavaScript
[55a]: https://de.wikipedia.org/wiki/JavaScript_Object_Notation
[55b]: https://en.wikipedia.org/wiki/JSON
[56a]: https://de.wikipedia.org/wiki/Integrated_Services_Digital_Network
[56b]: https://en.wikipedia.org/wiki/I ntegrated_Services_Digital_Network
[57]: https://servicenummern.telekom.de/weitere-informationen/anrufertarife/
[58]: https://woopla.de/service-rufnummern/0900-premium-rate/
[59a]: https://de.wikipedia.org/wiki/Peer-to-Peer
[59b]: https://en.wikipedia.org/wiki/Peer-to-peer
[60a]: https://de.wikipedia.org/wiki/Suchmaschinenoptimierung
[60b]: https://en.wikipedia.org/wiki/Search_engine_optimization
[61a]: https://de.wikipedia.org/wiki/Telefonanlage
[61b]: https://en.wikipedia.org/wiki/Business_telephone_system
[62a]: https://de.wikipedia.org/wiki/Vermittlungsstelle
[62b]: https://en.wikipedia.org/wiki/Telephone_exchange
[63a]: https://de.wikipedia.org/wiki/Extensible_Markup_Language
[63b]: https://en.wikipedia.org/wiki/XML

1. Apparatus for retrieving a website from a web server and for establishing a communication connection, comprising:
a send/receive interface configured to request a transmission of the website from the web server, and configured to receive the website from the web server,
an output module configured to output the website to a user, wherein the output module further indicates to the user that there is the possibility to establish the communication connection, wherein the communication connection is an audio connection or an audio/video connection or a video connection, and
an input interface configured to receive an input of the user, by which the user indicates that the communication connection is to be established,
a processor module configured to generate a connection-establishment message that requests the establishment of the communication connection with a communication unit,
wherein the send/receive interface is configured to send the connection-establishment message to a switching center,
wherein the send/receive interface is configured to, after sending the connection-establishment message, send audio data or audio/video data or video data to the communication unit and to receive the same from the communication unit.

2. Apparatus according to claim 1,
wherein the processor module is configured to generate the connection-establishment message used for requesting the establishment of the communication connection with the communication unit such that the connection-establishment message does not comprise any information that identifies the user of the apparatus.

3. Apparatus according to claim 2,
wherein the send/receive interface is configured to send to the switching center a registration message used for requesting a registration, wherein the registration message does not comprise any information that identifies the user of the apparatus,
wherein the send/receive interface is configured to acquire a response message from the switching center, wherein the response message comprises a registration identifier, and
wherein the processor module is configured to generate the connection-establishment message used for requesting the establishment of the communication connection with the communication unit such that the connection-establishment message comprises the registration identifier.

4. Apparatus according to claim 1,
wherein the output module comprises a display,
wherein the output module is configured to output the website on the display,
wherein the output module indicates to the user that there is the possibility to establish the communication connection by displaying a clickable link or a clickable button.

5. Apparatus according to claim 4,
wherein, upon clicking the clickable link or the clickable button, the processor module is configured to generate the connection-establishment message, and the send/receive interface is configured to send the connection-establishment message to the switching center without a further interaction with the user.

6. Apparatus according to claim 1,
wherein the output module comprises a display,
wherein the output module is configured to output the website on the display,
wherein the output module indicates to the user that there is the possibility to establish the communication connection by displaying a clickable link or a clickable button,
wherein the send/receive interface is further configured to, after the audio data or the audio/video data or the video data has been sent to the communication unit and has been received by the communication unit, acquire a payment request message from the communication unit,
wherein the output module is configured to output on the display a further website that displays a payment form, wherein payment data may be entered into the payment form,
wherein the send/receive interface is configured to send to a payment service server payment data that was entered into the input form and that instructs a payment.

7. System for retrieving a website, for providing the website and for establishing a communication connection, comprising:
an apparatus according to claim 1, and
a web server,
wherein a send/receive interface of the apparatus according to claim 1 is configured to request a transmission of the website from the web server,
wherein the web server is configured to receive from the apparatus according to claim 1 a message used for requesting the transmission of the website from the web server, and
wherein the web server is configured to send the website to the apparatus according to claim 1,
wherein the send/receive interface of the apparatus according to claim 1 is configured to receive the website from the web server,
wherein an output module of the apparatus according to claim 1 is configured to output the website to a user, wherein the output module indicates to the user that there is the possibility to establish the communication connection, wherein the communication connection is an audio connection or an audio/video connection or a video connection, and
wherein an input interface of the apparatus according to claim 1 is configured to receive an input of the user, by which the user indicates that the communication connection is to be established,
wherein a processor module of the apparatus according to claim 1 is configured to generate a connection-establishment message that requests the establishment of the communication connection with a communication unit,
wherein the send/receive interface of the apparatus according to claim 1 is configured to send the connection-establishment message to a switching center,
wherein the send/receive interface of the apparatus according to claim 1 is configured to, after sending the connection-establishment message, send audio data or audio/video data or video data to the communication unit and to receive the same from the communication unit.

8. System according to claim 7,
wherein the system comprises the switching center and the communication unit,
wherein the switching center is configured to acquire from the communication unit a signal that a first communication connection between the communication unit and the apparatus according to claim 1 is to be forwarded to a further communication unit,
wherein the switching center is configured to indicate to the further communication unit that the first communication connection between the communication unit and the apparatus according to claim 1 is to be forwarded to the further communication unit, and
wherein the switching center is configured to transfer to the further communication unit further data which the switching center received from the apparatus according to claim 1, which differs from the audio data or the audio/video data or the video data.

9. System according to claim 8, wherein the further data that differs from the audio data or the audio/video data or the video data is a code of a website that is displayed by the apparatus according to claim 1.

10. System according to claim 7,
wherein the system further comprises an authorization server,
wherein the send/receive interface of the apparatus according to claim 1 is further configured to, after the audio data or the audio/video data or the video data has been sent to the communication unit and has been received by the communication unit, acquire a payment request message from the communication unit,
wherein the output module of the apparatus according to claim 1 is configured to output on the display a further website which displays a payment form, wherein payment data may be entered into the payment form,
wherein the payment form comprises input fields for authorization data,
wherein the send/receive interface of the apparatus according to claim 1 is configured to send to the authorization server the authorization data that was entered by the user into the input fields of the input form,
wherein the output module of the apparatus according to claim 1 is configured to output on the display the further website that displays the payment form, so that a user name and a password may be requested as the authorization data by the payment form,
wherein the system further comprises a payment service server,
wherein the send/receive interface is configured to send to the payment service server payment data that was entered into the input form and that instructs a payment,
wherein the payment service server is configured to process the payment data.

11. Switching center, comprising:
a receive interface, and
a send interface,
wherein the receive interface is configured to receive a connection-establishment message from an apparatus,
wherein the receive interface is configured to, after receiving the connection-establishment message of the apparatus, receive audio data or audio/video data or video data as first audio data or as first audio/video data or as first video data from the apparatus,
wherein the send interface is configured to send the first audio data or the first audio/video data or the first video data received from the apparatus to a communication unit,
wherein the receive interface is configured to, after receiving the connection-establishment message of the apparatus, receive from the apparatus further data that is different from the audio data or the audio/video data or the video data,
wherein the send interface is configured to send the further data to the communication unit,
wherein the receive interface is configured to receive second audio data or second audio/video data or second video data from the communication unit,
wherein the send interface is configured to send the second audio data or the second audio/video data or the second video data received from the communication unit to the apparatus.

12. Switching center according to claim 11,
wherein the switching center is configured to acquire from the communication unit a signal that a first communication connection between the communication unit and the apparatus is to be forwarded to a further communication unit,
wherein the switching center is configured to indicate to the further communication unit that the first communication connection between the communication unit and the apparatus is to be forwarded to the further communication unit, and
wherein the switching center is configured to transfer to the further communication unit the further data that the switching center has received from the apparatus, which differs from the audio data or the audio/video data or the video data.

13. Switching center according to claim 12, wherein the further data that differs from the audio data or the audio/video data or the video data is a code of a website that is displayed by the apparatus.

14. Web server for providing a website for a terminal device, comprising:
a receive interface configured to receive from the terminal device a message used for requesting the transmission of the website from the web server, and
a send interface configured to send the website and address information to the terminal device,
wherein the address information comprises at least two addresses, wherein each of the at least two addresses designates the address of a respective one of at least two communication units; or
wherein the web server comprises an analysis unit configured to select one of at least two addresses as the address information, wherein each of the at least two addresses designates the address of a respective one of at least two communication units, wherein the analysis unit is configured to select the address depending on the message received from the terminal device; or
wherein the web server comprises the analysis unit configured to select one of at least two addresses as the address information, wherein each of the at least two addresses designates the address of a respective one of at least two communication units, wherein the analysis unit is configured to select the one address depending on websites previously retrieved by the terminal device.

15. Method for retrieving a website from a web server and for establishing a communication connection, comprising:
requesting the transmission of the website from the web server and receiving the website from the web server,
outputting the website for a user, wherein the output module further indicates to the user that there is the possibility to establish the communication connection, wherein the communication connection is an audio connection or an audio/video connection or a video connection, and
receiving an input of the user, by which the user indicates that the communication connection is to be established,
generating a connection-establishment message that requests the establishment of the communication connection with a communication unit, wherein the connection-establishment message comprises the address information indicating the address of the communication unit,
sending the connection-establishment message to a switching center,
after sending the connection-establishment message, sending audio data or audio/video data or video data to the communication unit and receiving audio data or audio/video data or video data from the communication unit.

16. Method, comprising:
receiving a connection-establishment message from an apparatus by a switching center,
after receiving the connection-establishment message from the apparatus, receiving audio data or audio/video data or video data as first audio data or as first audio/video data or as first video data from the apparatus by the switching center,
sending the received first audio data or first audio/video data or first video data from the switching center to a communication unit,
after receiving the connection-establishment message from the apparatus, receiving further data from the apparatus by the switching center, which differs from the audio data or the audio/video data or the video data,
sending the further data from the switching center to the communication unit,
receiving second audio data or second audio/video data or second video data from the communication unit by the switching center,
sending the received second audio data or second audio/video data or second video data from the switching center to the apparatus

17. Method for providing a website for a terminal device, comprising:
receiving from the terminal device a message used for requesting the transmission of the website from the web server, and
sending the website and address information to the terminal device,
wherein the address information comprises at least two addresses, wherein each of the at least two addresses designates the address of a respective one of at least two communication units; or
wherein one of the at least two addresses is selected as the address information, wherein each of the at least two addresses designates the address of a respective one of the at least two communication units, wherein the one address is selected depending on the message received by the terminal device, or
wherein one of the at least two addresses is selected as the address information, wherein each of the at least two addresses designates the address of the respective one of the at least two communication units, wherein the one address is selected depending on websites previously received by the terminal device.

18. A non-transitory digital storage medium having a computer program stored thereon to perform the method for retrieving a website from a web server and for establishing a communication connection, comprising
requesting the transmission of the website from the web server and receiving the website from the web server,
outputting the website for a user, wherein the output module further indicates to the user that there is the possibility to establish the communication connection, wherein the communication connection is an audio connection or an audio/video connection or a video connection, and
receiving an input of the user, by which the user indicates that the communication connection is to be established,
generating a connection-establishment message that requests the establishment of the communication connection with a communication unit, wherein the connection-establishment message comprises the address information indicating the address of the communication unit,
sending the connection-establishment message to a switching center,
after sending the connection-establishment message, sending audio data or audio/video data or video data to the communication unit and receiving audio data or audio/video data or video data from the communication unit,
when said computer program is run by a computer.

19. A non-transitory digital storage medium having a computer program stored thereon to perform the method, comprising:
receiving a connection-establishment message from an apparatus by a switching center,
after receiving the connection-establishment message from the apparatus, receiving audio data or audio/video data or video data as first audio data or as first audio/video data or as first video data from the apparatus by the switching center,
sending the received first audio data or first audio/video data or first video data from the switching center to a communication unit,
after receiving the connection-establishment message from the apparatus, receiving further data from the apparatus by the switching center, which differs from the audio data or the audio/video data or the video data,
sending the further data from the switching center to the communication unit, receiving second audio data or second audio/video data or second video data from the communication unit by the switching center,
sending the received second audio data or second audio/video data or second video data from the switching center to the apparatus,
when said computer program is run by a computer.

20. A non-transitory digital storage medium having a computer program stored thereon to perform the method for providing a website for a terminal device, comprising:
receiving from the terminal device a message used for requesting the transmission of the website from the web server, and
sending the website and address information to the terminal device,
wherein the address information comprises at least two addresses, wherein each of the at least two addresses designates the address of a respective one of at least two communication units; or
wherein one of the at least two addresses is selected as the address information, wherein each of the at least two addresses designates the address of a respective one of the at least two communication units, wherein the one address is selected depending on the message received by the terminal device, or
wherein one of the at least two addresses is selected as the address information, wherein each of the at least two addresses designates the address of the respective one of the at least two communication units, wherein the one address is selected depending on websites previously received by the terminal device,
when said computer program is run by a computer.
